(19) United States
(12) Patent Application Publication
(10) Pub. No.: US 2014/0288686 A1
(43) Pub. Date: Sep. 25, 2014

(54) METHODS, SYSTEMS, DEVICES AND COMPUTER PROGRAM PRODUCTS FOR MANAGING PLAYBACK OF DIGITAL MEDIA CONTENT

(71) Applicant: OMNIFONE LTD., London (GB)

(72) Inventors: Philip Anthony Sant, London (GB); Dominic Blatchford, London (GB); Neal Hart, London (GB); Matthew White, London (GB); Matthew Tighe, London (GB)

(21) Appl. No.: 14/355,422

(22) PCT Filed: Oct. 31, 2012
(86) PCT No.: PCT/GB2012/052705

§ 371 Date: Apr. 30, 2014

(30) Foreign Application Priority Data
Oct. 31, 2011 (GB) 1118784.6
Jan. 4, 2012 (GB) 1200073.3
Mar. 21, 2012 (GB) 1204966.4
Oct. 24, 2012 (GB) 1219113.6
Oct. 24, 2012 (GB) PCT/GB2012/052634

(51) Int. Cl. G06F 3/16

(52) U.S. Cl. CPC G06F 3/165
USPC 700/94

(57) ABSTRACT

A method is provided for managing playback of one or more items of digital media content, for example to ensure naturalistic transitioning between items of digital media content, comprising the steps of: (a) identifying a description which defines how to manage the playback of one or more items of digital media content, the description including descriptive metadata, and (b) utilising the description within a digital media player to control automatically the playback of digital media content. Associated systems, computer program products, digital media players and servers are also provided.

### BACKGROUND OF THE INVENTION

1. Field of the Invention

The field of the invention relates to methods for defining the playback criteria for one or more items of digital media content, for example to a method to ensure naturalistic transitioning between items. The field of the invention includes systems, devices and computer program products related to the methods.

2. Description of the Prior Art

A common historical issue when playing back digital media content has been deciding how to manage the transition from one such piece of content to another.

Traditional solutions have included simple consecutive sequencing of content, with or without intervening gaps, or fading one item down and the other up, possibly overlapping (“cross-fading”).

However, each approach has its own problems: simple sequencing can feel jarring to the listener while cross-fading can often result in loss of impact, such as when a crescendo is faded down in order to fade in the following musical track.

The preferred embodiment of the present invention resolves these historical problems by disclosing mechanisms to aid in smoothing the transition from one item to the next, as disclosed below, and managing the presentation and/or playback of one or more items of digital media content.

A further problem is that of “dead air”—unintended or, to date, unavoidable silence during playback of digital media content. That is a particular problem for services which stream digital media content for playback on a client device, where network connection issues can result in silence when a particular piece of content has not yet finished downloading to the device at the point where the end user wishes to listen to that content.

That latter problem can result in stuttering during playback or in silent gaps during playback of a track, or at the start or end of a track.

Further, the action of changing between tracks—even when using simple cross-fading, which has existed in media players for some time, working by smoothing the transition from the end of one song and in to the next—can also produce similar problems of “dead air”, by delivering a hard stop, a shocking interruption to the media that was playing. When a user presses pause, skips to the next track, skips to a new point in the song or simply picks a new song he is instantly jarred from his listening experience and plunged in to silence. This breaks the effect, the illusion of the listener.

The preferred embodiment of the present invention covers every aspect of the user playback experience, but in addition it solves that historical problem by buying time which can be used to carry out necessary server calls and time which can be used to deliver a richer visual interface. By providing seamless transitioning by, amongst other things, using fallbacks and interstitials (both disclosed below) and intelligent fading, to enable “Disc Jockey Mark-up Language” (DJML)-enabled media players to automatically compensate for circumstances where content is not yet available or is of a different style from the previously-playing content, the preferred embodiment of the present invention enables the user to have a totally seamless experience, without “dead air”.

It is hard to describe the effect of a totally seamless interactive and adaptive dynamic music system because no such thing has existed previously.

The preferred embodiment of the present invention may, in some embodiments, utilise DSP (“Digital Signal Processing”) technology to calculate such metadata as the mood or tempo of digital media content.

### BRIEF SUMMARY OF THE INVENTION

According to a first aspect of the invention, there is provided a method for managing playback of one or more items of digital media content, for example to ensure naturalistic transitioning between items of digital media content, comprising the steps of:

(a) identifying a description which defines how to manage the playback of one or more items of digital media content, the description including descriptive metadata, and
(b) utilising the description within a digital media player to control automatically the playback of digital media content.

The method may be one in which the description for a specific item of digital media content includes metadata that identifies significant events or characteristics of that item and in which the digital media player then automatically uses that metadata to control the playback of that item.

The method may be one in which the description for a specific item of digital media content is a timeline description that identifies when in time significant events in the item occur or the location of those significant events.

The method may be one where the descriptive metadata about a digital media content file comprises one or more of the start point of actual content in a file; the end point of actual content in a file; the region or regions of the file which constitute vocals; the tempo of the media content; the mood of the media content; the pitch of the media content; “hooks” within the content; suitable fade in and fade out points; the positions of any choruses within the file; the locations and types of any beat points in the file; any overlay positions at which other content may be overlaid onto the digital media content during playback; and any other metadata which is relevant to controlling the playback of a digital media content file.

The method may be one where the descriptive metadata about a digital media content file is identified by applying Digital Signal Processing (DSP) technologies to the digital content file or is identified manually or is identified by a combination of both automated and manual processes.

The method may be one further including the step of creating a description defining how to manage playback, and that step is performed automatically or utilises a tool or tools created for that purpose or is performed manually or is performed by a combination of the listed approaches.

The method may be one where the description of how to manage playback includes one or more of a representation of the descriptive metadata about the digital media content, including but not limited to one or more of the start point of actual content in a file; the end point of actual content in a file; the region or regions of the file which constitute vocals; the tempo of the media content; the mood of the media content; the pitch of the media content; “hooks” within the content; suitable fade in and fade out points; the positions of any choruses within the file; the locations and types of any beat points in the file; any overlay positions at which other content may be overlaid onto the digital media content during playback; and any other metadata which is relevant to controlling the playback of a digital media content file.

The method may be one where the “hook” comprises one or more extracted sections of a track of audio and/or video content which are identified as (i) being representative of that track as a whole; or (ii) being the most recognisable part or parts of that track; or (iii) being the “best” parts of that track, however defined; or (iv) being related to one or more portions of another track, including but not limited to such portions of a track as are similar to portions of other tracks, such as tracks which start in a similar manner, however defined; or (v) being evocative of that track, however defined; or (vi) a combination of one or more of the listed criteria.

The method may be one where the “hook” is identified using one or more of digital signal processing (“DSP”) technology, manually or by any other method.

The method may be one where the “hook” comprises one or more hooks from one or more tracks (“per-track hooks”), such individual hooks being combined to constitute a single hook by means of one or more of cross-fading, juxtaposition or any other technique to combine digital media content.

The method may be one where the description of how to manage playback includes information concerning one or more of recommendations of requirements concerning how a digital media content file may be cached on a client device; “fallback” digital media content which may be played in place of the said digital media content file should that file be unavailable for any reason; recommendations or requirements as to which digital media content should be played after the said digital media content file; how to play the digital media content, in terms of which audio and/or video processing to apply, which initial volume to use for playback, how to apply normalisation of tracks or any other playback criteria; how to overlay, whether optionally or otherwise, one track onto another, such as defining commentary tracks of audio, video or text for presentation alongside a currently playing track; how to manage playback, including information concerning how to control the tempo and/or pitch of digital content during playback; any other types of sound processing to employ during playback, such as one or more of effects, equalization, volume normalization, compression or any other audio and/or video processing; how to manage the presentation of the digital media content to the end user in the client's user interface; and any other metadata which is relevant to controlling the playback of a digital media content file.

The method may be one where the description of how to manage playback includes technical information concerning one or more of how to manage the transition between two or more items of digital media content, including one or more of when to start and end the transition in the first file; when to start and end the transition “end point” in the second file; which transition effect or combination of transition effects to utilise; the duration for which to apply any such transition effects; which interstitials, if any, to utilise when transitioning from the first digital media content to the second; and any other metadata useful to defining the transitioning between digital content files.

The method may be one where the transition effect comprises one or more of linear, s-curve or parametric fading, fade-to-hold, fade-to-transition, slow fade, cross fade, fast cross fade, the timing of the effect, the duration of the effect or any other information relevant to applying a given transition effect.

The method may be one where automatic creation of the description is performed by a software application which generates a representation of an item of digital media content using descriptive metadata identified about that content to generate a description in some standardised format, such as XML, JSON or any other applicable format.

The method may be one where the description defining how to manage playback describes a sequence of one or more items of digital media content, defines any effects to apply during playback and how to manage the transition between each item of digital media content.

The method may be one where the said description is created using a software application which generates the said description from a manually or automatically provided list of digital media content files or excerpts from such files such that the said description generated in some standardised format, such as XML, JSON or any other applicable format.

The method may be one where a digital media content file itself includes a description which defines how to manage playback of one or more items of digital media content.

The method may be one where a digital media content file includes one or more excerpts from one or more digital media files and/or more than one digital media file.

The method may be one where the description of how to manage playback of digital content is used by a digital media player to control playback of digital media content, whether directly or indirectly or by way of a plug-in to a digital media player, with the goal of avoiding unintended silence—“dead air”—and/or of producing a seamless playback experience for the end user.

The method may be one wherein the digital media content is digital music content or digital video and audio content.

The method may be one wherein the digital media player is a smart phone or a tablet computer.

The method may be one wherein the descriptive metadata includes the point of audio end, as distinct to the end of the file, in that it specifies that part of a digital media file after which there is little or no effective audio content in that file.

The method may be one wherein the descriptive metadata includes the beginning of audio elements in an audio file.

The method may be one wherein the descriptive metadata includes one or more of or all of: General definition; Instructions for caching; Fallback playlist; Streaming playlist, and Links for requesting more playlist items.

The method may be one wherein the descriptive metadata includes information which is interpretable to define one or more of, or all of: Which track(s) to play; At which point to commence the playback of each track; At which point to end playback of each track; How to play each track, in terms of which audio and/or video processing to apply such as the initial volume to use for playback, how to apply normalisation of tracks or any other playback criteria; How to transition from and to each track, such as how to cross-fade between tracks and which interstitials (if any) to utilise to smooth that transition; Which track to play after a given track, given as a simple track identifier or as a set of selection criteria which the client application may use to choose from a selection of possible “next tracks”; How to handle the case where the “next track” is unavailable, whether temporarily or permanently, such as providing a pre-cached track to use as an alternative; How to manage the presentation of the track(s) to the end user in the client's user interface, and How to overlay, whether optionally or otherwise, one track onto another, such as defining commentary tracks of audio, video or text for presentation alongside a currently playing track.

The method may be one wherein the method further includes the step of: after opening a session/web player/software app on the digital media player, audio is played only in response to a user-instigated play action.

The method may be one wherein the method includes a method for presenting a user interface to an end user to facilitate the searching, browsing and/or navigation of digital media content, the method comprising the steps of:

(a) analysing the digital media content to create “hooks” related to the digital media content, or retrieving “hooks” in the digital media content, and
(b) replacing or augmenting a graphical or textual representation of the digital media content with the “hooks.”

According to a second aspect of the invention, there is provided a method of analysing digital content, comprising the steps of:

(a) identifying a collection of digital media files;
(b) performing DSP analysis of the collection of digital media files to automatically generate the audio start and end points within the files, and
(c) generating and storing metadata based on the DSP analysis.

The method may be one further comprising the step of: performing DSP analysis of the digital media files to automatically identify the tempo and mood of music within the files.

The method may be one further comprising the step of: performing DSP analysis of the digital media files to automatically identify potential overlay points (places where audio may be overlayed onto the file), or to automatically identify “hooks”, or to automatically identify additional metadata which is automatically derivable from automated analysis of the digital media files.

According to a third aspect of the invention, there is provided a collection of digital media content files, the collection including an associated description which defines how to manage playback of one or more items of digital media content, the description including descriptive metadata. The collection may include one or more interstitial files.

According to a fourth aspect of the invention, there is provided a system including a digital media player and a content server, the digital media player connectable to the content server via a content delivery network, the content server operable to provide content delivery to the digital media player in response to calls to the content server from the digital media player, wherein the system is operable to

(a) identify a description which defines how to manage the playback of one or more items of digital media content, the description including descriptive metadata, and
(b) utilise the description within the digital media player to control automatically the playback of digital media content.

The system may be one wherein the digital media player is operable to identify a description which defines how to manage the playback of one or more items of digital media content, the description including descriptive metadata.

The system may be one wherein the content server is operable to identify a description which defines how to manage the playback of one or more items of digital media content, the description including descriptive metadata, and to transmit the description to the digital media player.

According to a fifth aspect of the invention, there is provided a system including a digital media player, an identification server and a content server, the digital media player, the identification server and the content server connectable to each other via a content delivery network, the content server operable to provide content delivery to the digital media player in response to calls to the content server from the digital media player, wherein

(a) the identification server is operable to identify a description which defines how to manage the playback of one or more items of digital media content, the description including descriptive metadata,
(b) the identification server is operable to transmit the description to the digital media player, and
(c) the digital media player is operable to utilise the description to control automatically the playback of digital media content.

The system according to the fourth or fifth aspects of the invention may be one wherein the system is operable to implement any of the methods of the first or second aspects of the invention.

According to a sixth aspect of the invention, there is provided a digital media player forming part of a system according to the fourth or fifth aspects of the invention.

According to a seventh aspect of the invention, there is provided a content server forming part of a system according to the fourth or fifth aspects of the invention.

According to an eighth aspect of the invention, there is provided an identification server forming part of a system according to the fifth aspect of the invention.

According to an ninth aspect of the invention, there is provided an computer program product operable to perform a method of managing playback of one or more items of digital media content, for example to ensure naturalistic transitioning between items of digital media content, the computer program product operable to perform the steps of:

(a) identifying a description which defines how to manage the playback of one or more items of digital media content, the description including descriptive metadata, and
(b) utilising the description within a digital media player to control automatically the playback of digital media content.

The computer program product may be operable to implement any of the methods of the first or second aspects of the invention.

The preferred embodiment of the present invention discloses a method for marking up a “timeline” of one or more items of digital media content so as to assist a client application to analyse, navigate, search or render (“play” or “playback”) that digital media content in a user-friendly manner.

At its core, the preferred embodiment of the present invention requires:

1. Identifying descriptive metadata about digital media content files, such as the start and end points of actual content in a file, the tempo, mood, “hooks” within the content and so forth, whether by Digital Signal Processing (DSP) or manually or by a combination of both.
2. Creating a description using that metadata which defines how to play one or more items of digital media content, controlling not only the items of digital content themselves but also the way in which they transition and overlap.
3. Utilising that description within a digital media player to provide a seamless content playback experience.

The mark up language described herein represents an example embodiment only: any suitable language with equivalent or suitable semantics may be used to instantiate an embodiment of the present invention.

### BRIEF DESCRIPTION OF THE FIGURES

FIG. 1 shows dominos illustrating Interstitial matching figuratively.

FIG. 2 shows an illustration of cross-fading.

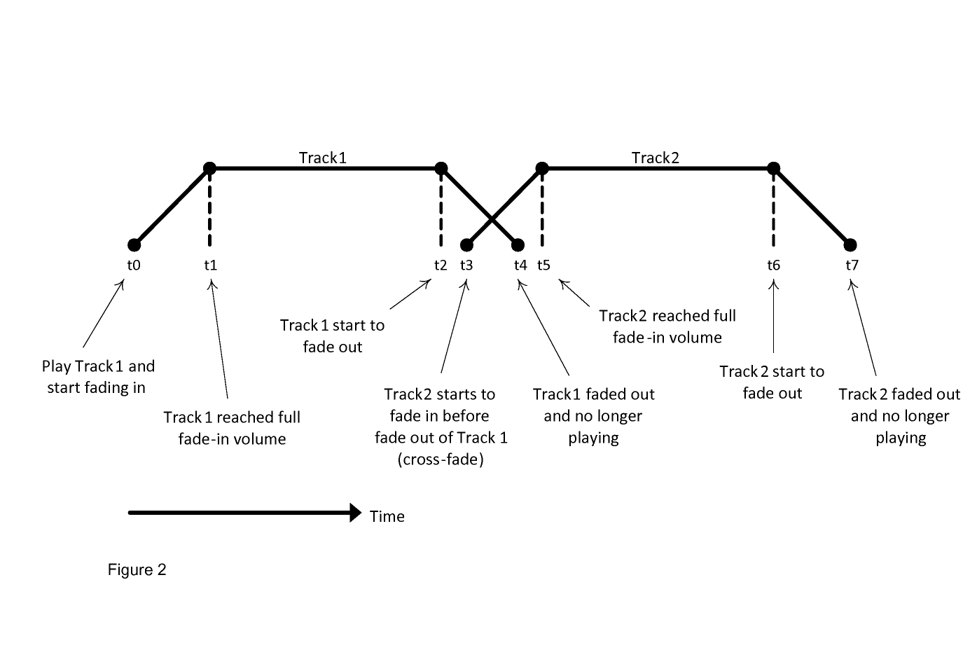

FIG. 3 shows an example of a Slow Fade (10 seconds).

FIG. 4 shows an example of a Slow Fade switching to a Fast X-Fade (right).

FIG. 5 shows an example of a Fast X-Fade.

FIG. 6 shows an example of pause-and-play x-fade.

FIG. 7 shows an example of Seeking Within A Single Audio Stream.

FIG. 8 shows an example of Extensible Markup Language (XML) implementing part of the present disclosure, which continues into FIG. 9.

FIG. 9 shows an example of XML mark up implementing part of the present disclosure, which continues from FIG. 8. The code of FIGS. 8 and 9 forms a single portion of code.

FIG. 10 shows a waveform representation of audio, indicating identified hooks.

FIG. 11 shows an example of a system including a digital media player, a content delivery network and a content server, the digital media player connectable to the content server via the content delivery network, the content server operable to provide content delivery to the digital media player in response to calls to the content server from the digital media player, wherein the system is operable to

(a) identify a description which defines how to manage the playback of one or more items of digital media content, the description including descriptive metadata, and
(b) utilise the description within the digital media player to control automatically the playback of digital media content.

FIG. 12 shows an example of a system including a digital media player, a content delivery network, an identification server and a content server, the digital media player, the identification server and the content server connectable to each other via the content delivery network, the content server operable to provide content delivery to the digital media player in response to calls to the content server from the digital media player, wherein

(a) the identification server is operable to identify a description which defines how to manage the playback of one or more items of digital media content, the description including descriptive metadata,
(b) the identification server is operable to transmit the description to the digital media player, and
(c) the digital media player is operable to utilise the description to control automatically the playback of digital media content.

### DETAILED DESCRIPTION

### Definitions

For convenience, and to avoid needless repetition, the terms “music” and “media content” in this document are to be taken to encompass all “media content” which is in digital form or which it is possible to convert to digital form—including but not limited to books, magazines, newspapers and other periodicals, video in the form of digital video, motion pictures, television shows (as series, as seasons and as individual episodes), computer games and other interactive media, images (photographic or otherwise) and music.

Similarly, the term “track” indicates a specific item of media content, whether that be a song, a television show, an eBook or portion thereof, a computer game or any other discreet item of media content.

The terms “playlist”, “timeline” and “album” are used interchangeably to indicate collections of “tracks” and/or interstitials which have been conjoined together such that they may be treated as a single entity for the purposes of analysis or recommendation.

A “timeline” can also refer to any time-indexed data or metadata; DJML is an instance of time-indexed items, specifically metadata.

The terms “digital media catalogue”, “digital music catalogue”, “media catalogue” and “catalogue” are used interchangeably to indicate a collection of tracks and/or albums to which a user may be allowed access for listening purposes. The digital media catalogue may aggregate both digital media files and their associated metadata or, in another example embodiment, the digital media and metadata may be delivered from multiple such catalogues. There is no implication that only one such catalogue exists, and the term encompasses access to multiple separate catalogues simultaneously, whether consecutively, concurrently or by aggregation. The actual catalogue utilised by any given operation may be fixed or may vary over time and/or according to the location or access rights of a particular device or end-user.

The abbreviation “DRM” is used to refer to a “Digital Rights Management” system or mechanism used to grant access rights to a digital media file.

The verbs “to listen”, “to view” “to playback” and “to play” are to be taken as encompassing any interaction between a human and media content, whether that be listening to audio content, watching video or image content, reading books or other textual content, playing a computer game, interacting with interactive media content, analysing, navigating or searching that media content or some combination of such activities.

The terms “user”, “consumer”, “end user” and “individual” are used interchangeably to refer to the person, or group of people making use of the facilities provided by the interface. In all cases, the masculine includes the feminine and vice versa.

The terms “device” and “media player” are used interchangeably to refer to any computational device which is capable of playing digital media content, including but not limited to MP3 players, television sets, home entertainment system, home computer systems, mobile computing devices, games consoles, handheld games consoles, IVEs or other vehicular-based media players or any other applicable device or software media player on such a device. Something essentially capable of playback of media.

The term “DSP” (“Digital Signal Processing”) refers to any computational processing of digital media content in order to extract additional metadata from that content. Such calculated metadata may take a variety of forms, including deriving the tempo of a musical track or identifying one or more spots within the digital media file which are gauged to be representative of that content as a whole.

The term “hook” is used to refer to one or more portions of a digital media file which have been identified, whether via DSP or manually or by some other method, as being representative of the content as a whole. For example, a movie trailer consists of a series of one or more “hooks” from the movie while particularly apposite riffs or lines from a musical track serve a similar identifying purpose.

The terms “UX” and “user experience” are used interchangeably to refer to the experience which an end-user has when interacting with a particular embodiment of the present invention.

The term “X-fade” is used as an abbreviation for “cross-fade”, the act of transitioning playback from one track to another by fading down the playing track then, at some point in that transition, fading up the next track. The precise mechanism used in fading down and up tracks and the timing involves may vary between different X-fade techniques, as disclosed in detail below.

The term “JSON” refers to “JavaScript Object Notation”, a standard industry format used to describe data and metadata.

The terms “DJML” and “Disc Jockey Mark-up Language” are used interchangeably throughout to refer to any example embodiment of the present invention, including but not limited to its main embodiment, or to a digital media player which is built so as to implement one or more features enabled by the preferred embodiment of the present invention.

### Description—Introduction

When further functionality is paired with this concept the system becomes an incredibly powerful music system that allows the user to hear the best, most exciting and recognisable part of a song and from there they can play from the start or skip to the next. This means that basic navigation (if applied or switched on) can turn in to a fast decision making process void of any user disappointments . . . it become an interactive X-Faded discovery method akin to a professional and highly produced media experience such as adverts or radio stations.

The preferred embodiment of the present invention discloses, in its most general form, a method for defining a timeline of tracks for playback and how those tracks are to be played and transitioned between.

One example implementation of the present invention is to define what is essentially a radio station as a series of tracks, interstitials, DJ commentaries, advertisements or any other items and the method(s) of transitioning between each.

In that example, a radio station would be defined solely in terms of DJML, for “Disc Jockey Mark-up Language”, with a suitable client device simply implementing the directives of that mark-up to retrieve identified tracks and transition between them, as directed, in sequence, to recreate the experience of a radio station.

Another example implementation of the present invention allows a tool to be used to mix tracks using defined cross-fading or other transitional techniques, the output of that tool being a DJML file which may be played back using any DJML-capable client application or device.

In its preferred embodiment, the present invention provides a method to specify a playlist of audio and video elements which includes rich metadata controlling not only the tracks and video themselves but also the way in which they transition and overlap.

DJML is intended to provide an experience like and beyond traditional broadcast and beyond.

### Identifying Descriptive Metadata

The cornerstone of DJML is the definition of index points within known content. For example marking:
The beginning of the audio elements in an audio file
The vocal part of a track
Ideal in and out fade points
Multiple chorus/hook points
Points of no audio or quiet audio
Points of interest
Beat positions
The point of audio end, as distinct to the end of the file, in that it specifies that part of a digital media file after which there is little or no effective audio content in that file.
Any other descriptive metadata which is relevant to playback in a DJML-enabled player

The descriptive metadata described may be automatically generated by applying Digital Signal Processing (DSP) technologies to digital media content files. In another example embodiment, that metadata is generated manually. In the preferred embodiment, that metadata is generated automatically in the first instance and then augmented or adjusted manually using tools developed for that purpose.

Once known, those points allow, in the preferred embodiment, the automatic generation of DJML mark-up for a given sequence of tracks.

By the same token, in one example embodiment DJML could be manipulated manually to create a specific mix such as would be produced by a disc jockey. That could take the form of playlists or slide shows, with DJML allowing for easy construction of music or video experiences.

### Representing Playback Metadata

DJML is, in the preferred embodiment, represented as an XML language mark-up. Any other semantically equivalent form of mark up, such as JSON or a binary data stream, may be utilised in other example embodiments. DJML could also be represented, in another example embodiment, as a set of extensions for an existing playlist language such as Synchronized Multimedia Integration Language (SMIL) v3.

For clarity, the example below is presented in the XML format utilised by the preferred embodiment of DJML. However its constructs should not be limited to this expression as it could easily be expressed in other languages where required.

An example of a fairly standard XML representation of DJML is presented below.

This shows the basic structure which is:
1. General definition
2. Instructions for caching
3. Fallback playlist
4. Streaming playlist
5. Links for requesting more playlist items

Of particular importance is item 5, links for requesting more playlist items. A DJML playlist may contain only a single track and a link. The link is used by the client to request the next track in the cases of dynamically generated playlists. The link would return valid DJML which is considered in the context of the existing DJML data.

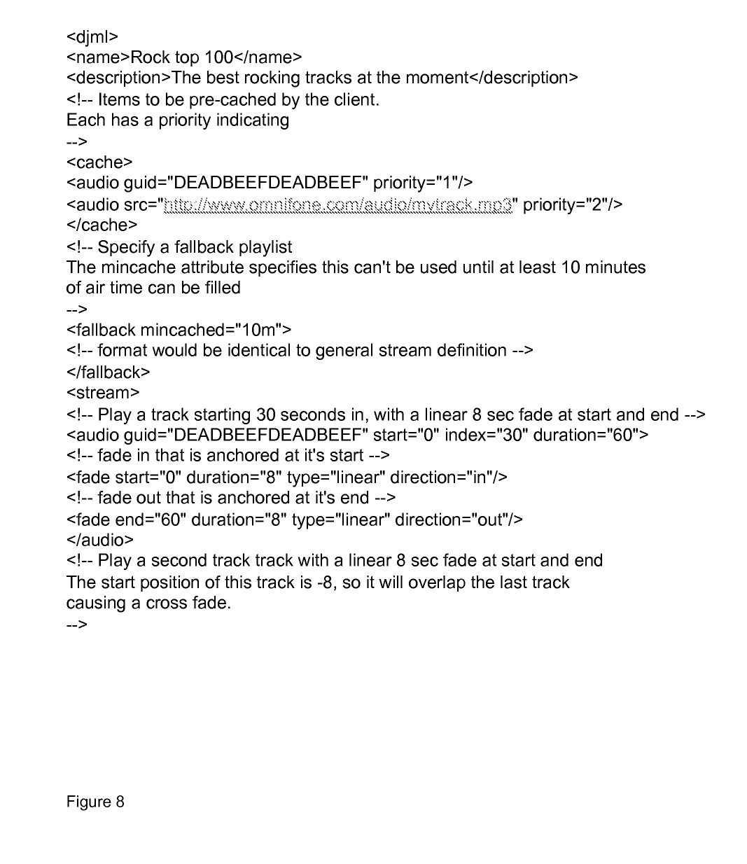

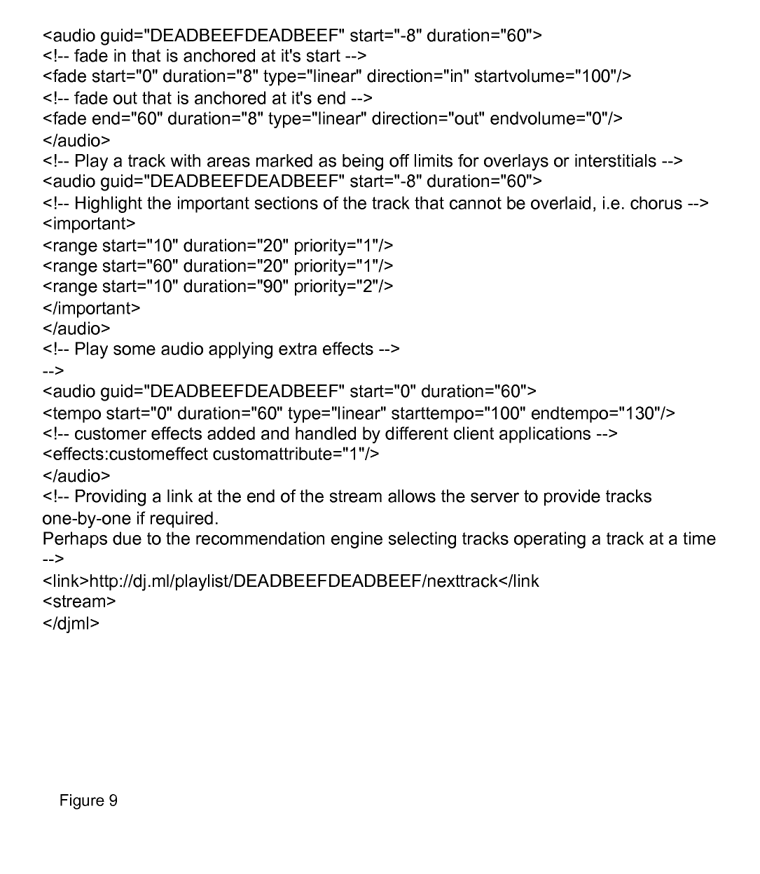

An example of XML mark up implementing part of the present invention is shown in FIGS. 8 and 9.

The actual mark up terms—such as tag names, attribute names, available attributes and implementation language—may vary from embodiment to embodiment as required or desired for a given implementation of the present invention.

In the preferred embodiment, some of the basic metadata encapsulated in DJML markup is automatically generated based on DSP (“Digital Signal Processing”) of digital media files. In other example embodiments, that metadata is created and/or fine-tuned manually. Examples of metadata which is generated automatically in the preferred embodiment include the audio start and end points within a file, the tempo and mood of music within a file, the initial identification of potential overlay points (places where audio may be overlayed onto the file), the identification of “hooks” and any additional metadata which may be automatically derived from automated analysis of that digital media file.

### Defining Playback

The mark up language disclosed enables the client application to be informed of information such as one or more of:
Which track(s) to play.
At which point to commence the playback of each track.
At which point to end playback of each track.
How to play each track, in terms of which audio and/or video processing to apply such as the initial volume to use for playback, how to apply normalisation of tracks or any other playback criteria.
How to transition from and to each track, such as how to cross-fade between tracks and which interstitials (if any) to utilise to smooth that transition.
Which track to play after a given track, given as a simple track identifier or as a set of selection criteria which the client application may use to choose from a selection of possible “next tracks”.
How to handle the case where the “next track” is unavailable, whether temporarily or permanently, such as providing a pre-cached track to use as an alternative.
How to manage the presentation of the track(s) to the end user in the client's user interface.
How to overlay, whether optionally or otherwise, one track onto another, such as defining commentary tracks of audio, video or text for presentation alongside a currently playing track.
Any other relevant criteria.

The preferred embodiment of the present invention may make use of interstitials designed, or in the preferred embodiment custom built on-the-fly, to aid the transition from one item of digital media content to the next.

Such interstitials may be branding, advertisements or simply transitional elements, and are constructed or selected on the basis of manual or DSP analysis of the starting point (the media item which is transitioned from) and the ending point (the media item which is to be transitioned to) and the actual or proposed interstitial element, as disclosed herein.

The audio elements controlled by DJML can include but are not limited to:
Tracks
Audio audition
Interstitials
Talk overs/overlays/tutorials/help/notifications
Transitions
Adverts
Multi-media element mixing
Beat and Key matching
Rich metadata connected to unique media (genre, tempo, other relational links)
Spectral Audio data (moods, energy, etc can be identified)
Presentation and user playlist/show reel/slide show editing
Synchronisation between clients based on DJML metadata

DJML is intended to provide a client application with all the data it needs to implement a modern and future digital broadcast quality experience by implementing a set of simple constructs. It is based on the principle of a running timeline with various content-related events such as starting or ending or altering the playback of a given item or items on that timeline.

DJML can be used to control the playback of any number of audio elements, which can overlap. In the preferred embodiment, each element can be controlled in the following ways:
Start time/end within the content itself, such as “start playing 8 seconds into the content.”
Relative position based on the beginning or end playing content (overlap), such “being playing 10 seconds before the current track finishes.”
Fade/cross-fade start and end points, including contextual fade strategy
Including type of fade (such as linear, s-curve or parametric fading) and the parameters required to define the fade, such as duration of data points on curve.
Tempo/Pitch/Time
Controlling the general tempo and pitch adjustment of content.
Other types of sound processing, including effects.
Equalization, volume normalization, compression and other audio and video processing.
Contextual User Interface Audio handling based on the data provided in the DJML timeline and unique media data provided within.

Example embodiments may implement one or more or all of the techniques outlined above.

DJML, in its preferred embodiment, enables the client application to manage the entire audio experience for the user. This includes deciding when to cross-fade a piece of media in order to transition to the next element. Examples would be pausing a track, switching tracks, exploring an artist's collection of works and/or switching to a new channel.

APPENDIX B describes various use cases, as utilised in the preferred embodiment of the present invention, where DJML is used to control the operation of a digital media player to provide a seamless experience for the end user. A given example embodiment need not implement every single use case so described.

### Controlling Caching

In its preferred embodiment, the present invention allows the definition as to which elements of the audio/channel/playlist experience should be pre-cached and in what order and with what priority, as well as controlling the live streaming aspects of playback.

Control includes:
How many content items get download at once.
In which order.
Duration for which client should cache each item.

For example, some interstitials such as jingles or generic talk overs for a channel could be pre-loaded and stored by the client application for use later, at defined points in the timeline.

### Avoidance of Dead Air

In historical media players, there is a delay, a gap of silence, when playing song after song, skipping or simply selecting a track to play. That ‘delay’ or ‘silence’ is caused by a number of things, the sum of which leads to a large perceived gap in the audio . . . a long pause of silence or “dead air”.

The primary reasons for this are, in no particular order, as follows:
Delay in requesting and receiving a URL for the next track, particularly in streaming media players
Speed of buffering and switching a player to a ready state, i.e. time to waiting for new buffer to fill and the player being ready to play.
The audio silence in every file at the beginning and end of songs: these can be quite long at the end of some media.
The natural fade out in some pieces of music, this can give the psycho-acoustic perception depending on the real world volume, that the audio gap is longer than it actually is.
In some UI implementations a timeout delay is added to ensure that the user who is skipping through selections doesn't trigger multiple requests for media they have no intention of playing. A typical value for this delay is 400 ms when skipping through with the player (not when selecting a new source for music)

DJML, in its preferred embodiment, allows the specification of a set of audio elements and metadata which can be used in an emergency to fill dead air if the client is unable to stream the next required piece of audio.

Such components would, in the preferred embodiment, be pre-cached up front using the caching rules, thus ensuring their availability for playback as needed.

### Positioning of Overlays and Interruptions

In the preferred embodiment, DJML allows the definition of which sections of time during playback of a timeline or a specific item are appropriate for audio overlays (such as notifications or DJ talk overs). This is to avoid dynamic overlays from talking over the important parts of the track such as the vocal or chorus. In some embodiments, a priority system may be used to further refine the definition.

### Interstitials—What is an Interstitial?

An interstitial is a, typically short, piece of digital media content which is designed to be incorporated between two other items of digital media content. In the context of the preferred embodiment of the present invention, major uses for interstitials would be, in various example embodiments:
To facilitate the transition between playback of two or more pieces of digital media content, as disclosed below.
To prevent silence (“dead air”) during playback, such as by providing a piece of “fallback” content to play in the case where the required content is not yet available.

For simplicity, interstitials are presented here in terms of audio clips for insertion between two other audio clips. However, similar and identical techniques to those which are disclosed below may also, in a further example embodiment of the present invention, be used to produce video or audiovisual interstitials—such as for movies, television shows or computer games—or any other appropriate digital media content.

Audio, audio-visual and/or visual interstitials may be used, in the preferred embodiment, to combine multiple identified “hooks” into a single overall “hook” for use with the matter disclosed in PCT Patent Application number PCT/GB2012/052634, entitled “METHOD, SYSTEM AND COMPUTER PROGRAM PRODUCT FOR NAVIGATING DIGITAL MEDIA CONTENT,” which is incorporated by reference. Selected content from PCT Patent Application number PCT/GB2012/052634 is provided in Appendix C. In the case of movies or television shows, for example, such multiple hooks combined using video interstitials could constitute a form of auto-generated advertising trailer for that content.

### Types of Interstitials

In the preferred embodiment, Interstitials may be of one or more of the following types:
Branding, such as Station Idents
Advertisements
Transitional Elements, such as aural/musical sequences to aid cross-fading between two music tracks.

Transitional elements may be pre-built or custom-constructed, as disclosed below.

In any event, each interstitial must be labelled—whether manually or by being processed via an appropriate DSP algorithm to determine its rhythm, mood, tempo and/or any other metadata relevant to its selection for use—to indicate to which kinds of transition (within the criteria specified) that interstitial is relevant.

For example, a given interstitial might be labelled as being suitable for cross-fading from a fast “rap” song (the starting point) to a slow piano tune (the destination point) while another might be similarly labelled as being suitable for the reverse transition.

Note that the labelling of interstitials may also, in the preferred embodiment, include additional metadata such as how that interstitial is to be introduced into the main playback stream. For example, an interstitial may be labelled as being suitable for cross-fading (where the interstitial is designed to be faded in as the outgoing track fades out), for simple sequencing insertion (where no fading is involved) either in combination with a silent gap or not.

In the preferred embodiment, the definition of how an interstitial may be used is specified according to its appropriate starting point, its appropriate destination point and its possible modes of playback for both its introduction and its coda. In the preferred embodiment, that metadata is marked up using a suitable mark-up language, such as that disclosed herein.

In another example embodiment, interstitials are labelled with only a combination of one or more of the metadata elements disclosed above for the preferred embodiment.

### Selection of Interstitials

Where an interstitial of whatever type is pre-built, the primary problem is the selection of an appropriate interstitial clip to use.

The initial data to be used to determine which interstitial to utilise is based on manual marking or DSP processing of:
The “start”, which is the place which is being transitioned from, such as the current location in a currently playing track (which may be the end of that track)
The “end”, which is the place which is being transitioned to, such as a “hook” or the start of the next track to play.

With those two locations processed via an appropriate DSP algorithm to determine their rhythm, mood, tempo and/or any other relevant metadata, the problem reduces to the selection of an interstitial of the required type which will smooth the transition between those two locations.

For example, if the “start” has an upbeat tempo and the “end” has a slow waltz beat then the chosen interstitial must be an audio clip which has been designed (or constructed) to smooth the transition between those two specific kinds of audio.

In the preferred embodiment, there are pre-existing interstitials which have been identified and labelled as being suitable for any given transition which may be produced from the digital media catalogue with which the preferred embodiment of the present invention is to operate.

Given the enormous number of possible combinations of start and end points, it may not be practical to build all possible interstitial elements, in which case custom interstitials must be built, as disclosed below.

### Constructing Custom Interstitials

A custom interstitial is, in the preferred embodiment, constructed by sequencing a series of pre-built interstitials by matching the head of the first such interstitial to the “start” point, as disclosed above, and matching the code of the final such interstitial to the “end” point of the transition, as also disclosed above.

Where no single interstitial matches both the start and the end points then additional interstitials may, in the preferred embodiment, be selected to complete the transition sequence.

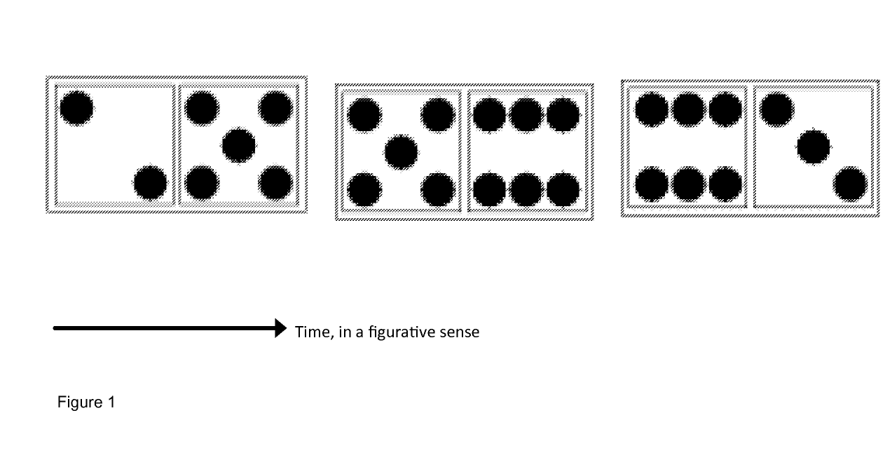

The basic approach is much as it is with dominoes, where the head and tail of each domino must match those to either side. FIG. 1 illustrates this approach, where the “start” point is “2”, the end point in “3” but no pre-built interstitial transitions directly from “2” to “3”. Thus, an intermediate interstitial “domino” is used to smooth that transition, going (in this example) from 2 to 5 to 6 to 3. If a shorter sequence could be found (such as 2-to-4-to-3, in this example) then that shorter sequence would, in the preferred embodiment, be used instead.

Such custom interstitials are, in the preferred embodiment, built on the fly where necessary and using the same playback rules as disclosed earlier for simple pre-built interstitials. In the preferred embodiment, custom interstitials are, once built, treated in precisely the same way as pre-built interstitials.

### Cross-Fading

Cross-fading between tracks and/or interstitials may be performed by lowering the volume of one track/interstitial while simultaneously raising the volume of the track/interstitial which is being faded to.

In the preferred embodiment, the present invention permits such cross-fading to be defined in terms of:
At which point in the currently playing track the cross-fading process is to start
Which point in the “next track” the cross-fading process is to cross fade to
Which technique(s) to utilise when cross-fading

Thus, a cross-fade is defined as the transition from one point in the first playing item to another point in the second playing item using a specified transitioning technique (or a set thereof).

The transitioning technique(s) to utilise are defined, in the preferred embodiment, as a duration for which to apply the given effect (where applicable, and where desirable in a given embodiment) and the effect(s) to apply. The effect to apply may be one or more of a linear, logarithmic, sine, cosine, s-curve, exponential or any other audio cross-fading technique. Similarly, in one example embodiment video cross-fading techniques such as wipe, bleaching, fade-to-black or any other video cross-fading techniques may also be defined where applicable.

In the preferred embodiment, the duration of effect and/or the effect to apply are defined for both the track being faded from and the track being faded to.

APPENDIX A provides a non-exhaustive definition of possible cross-fading effects used by the preferred embodiment of the present invention.

### Cross-Fading Streaming Media

When the digital media content is being streamed across a network, such as the internet or any other network, then the same cross-fading and interstitial selection of usage rules as disclosed above are used, with the addendum, in the preferred embodiment, that the “end” point needs to be buffered (i.e. sufficiently downloaded so as to enable DSP processing to identify suitable interstitials or to permit the tracks and/or interstitials to be appropriately blended by the client application).

Where such pre-buffering is not possible then, in the preferred embodiment, a suitably pre-identified interstitial may be used to insert into playback in order to avoid unwanted gaps or silence in playback.

### Cross-Fading Offline Files

The present invention, in its preferred embodiment, is able to manage playback of tracks whether those tracks are resident on the client device, streamed from another device or a remote server or need to be downloaded from a remote server or another device.

Where the track(s) are resident on the client device, the preferred embodiment of the present invention may manage playback of those tracks whether the device is online or offline, as required.

### Typical Applications of the Preferred Embodiment of the Present Invention

The present invention, in various example embodiments and including in its preferred embodiment, facilitates:
Listening to a broadcast quality channel on a subscription music service.

DJML would be used here to provide the metadata required by the client to cross fade between tracks and insert jingles, talk overs and interstitials at the appropriate points in the same way a traditional radio programmer would.
Listening to a preview of audio content constructed of the “hook” of each track cross fade smoothly together.

DJML would be used here to specify metadata around a playlist of tracks causing each track to be played starting at its hook time index for 8 seconds with a smooth cross fade between each track.
Providing DJ style mixes of audio content, such as replicating a live event or having a special mix of content produced.

DJML would be used to encode the start index and duration for each track and the custom cross-fade parameters between each piece of audio.
User-facing UI for producing mixes of content using DJML constructs, such as a user sharing his own mix of a track with friends.

DJML would be manipulated by the user via a graphical interface that allowed the audio components to be selected along with the overlays, effects and transitions between those components.
More naturalistic transitioning between tracks in a playlist.

Pressing ‘Next’ on a playing piece of audio within a DJML-enabled digital media player lowers the audio level using a fade, the fade time can be a default or it can be driven from the DJML data. The next track then starts at an appropriate time, either as a default or also based on DJML data.

An example would be ensuring that the next piece of media is played at a time driven by the tempo of the media being skipped. The new piece of media then plays (without a fade) from the beginning. The timing of exactly when this track starts is driven by DJML data. For example, if the new media has a strong clear loud start then DJML knows exactly where the audio begins in the file (i.e. 500 ms from the beginning of the file) this gives a very unique and controlled user experience in the audio and visual domain.
Smoother social network and messaging interactions.

If, when playing some digital media content, the end user receives a notification (such as a new message, a friend logging in, a status or system message and so forth), the application is able to delay the insertion of the notification because, as disclosed earlier, DJML can be used to specify the sections of the timeline during which an overlay can occur, including the time index to lower the main media audio, deliver the interrupt audio, and then fade back in to the playing media at a time that fits with the music.
A client application designed to allow users to create their own unique playlist/mix-tape/DJ style ‘set’ would utilize DJML to auto place musical tracks along an event timeline. A user could edit this and DJML would have index points and fade data that would allow for easy snapping to events.
An auto-generated playlist could be sequenced based on the “best match” elements as indicated by DJML.
A user's musical library could be shuffled to produce the best arrangement and sequence of music or media.

DJML and the metadata associated with each audio element would be used to produce a pleasing “mix” of complementary tempos/styles with seamless crossfades, based on the metadata encoded in the DJML markup combined, in some example embodiments, with additional metadata such as the specific user's preferences or settings.
By allowing cue points to be inserted, manually and/or automatically, and then a cross fade defined to create a DJ style effect, tempo and beat metadata encoded using the preferred embodiment of the present invention allows any EDM (Electronic Dance Music) type of music to be mixed.

### Selection of Next Track

Just as the processing and/or manual marking disclosed above may be used to select which interstitials to provide between two known tracks so similar processing may be used as (part of) the criteria when selecting which track to play subsequent to the currently playing track.

The selection of the next track to play may, in the preferred embodiment, be determined on the basis of one or more of the following criteria:
Music recommended by the recommendation engine(s) in use for the service on which the preferred embodiment of the present invention is being utilised;
The speed/tempo/genre/mood/era of the current and potential next tracks, as determined manually and/or via DSP processing, or any other criteria disclosed for use with interstitial selection which may aid in smoothing the transition from the current to a subsequent track;
Manual selection of the next track by the end user;
Any other relevant criteria.

### Additional Applications

The preferred embodiment of the present invention provides for several additional applications which have been touched upon in the disclosures above. In the preferred embodiment, the present invention permits tracks and timelines to be marked up to incorporate zero, one or many of the following metadata:
One or more commentary tracks, providing the end user with (possibly optional) commentary on the currently playing track.
Text for display at specified times during playback, possibly optionally, such as production notes, trivia or comments.
Karaoke lyrics and timings
The definition of video and/or audio trailers for video content—such as movies or television shows or series—in the form of DJML mark-up indicating which parts of the source video to playback, in which order, using which transitioning techniques and defining the overlaid commentary for the trailer if required. Similar tools to those disclosed above may be utilised to create the DJML definition of a trailer.
The definition of alternative tracks for playback based on access or rights issues. For example, if a radio station is defined in DJML, as disclosed above, but would ordinarily play a track which is unavailable in the locale in which the user is listening to that radio station then an alternative track may be specified in the mark-up, for playback by such users.
The method of marking up one or more tracks disclosed above is not limited to a single unified track but may also, in one example embodiment, be used to define how to mix individual channels to form a coherent track. For example, a mixing desk—or equivalent device or application—may be used to define how individual channels of music, effects and vocals are to be mixed to produce a given song, including transitioning effects and special effects where applicable. The output of that mixing desk would, in that example embodiment, be a piece of DJML mark up which defines that song in terms of its constituent parts. In a further example embodiment, various “remixes” of a track may be defined as alternative DJML definitions based on those core channel sounds.
In one example embodiment, DJML-capable processing is embedded into the firmware/hardware of a device to enable cross-fading at that low level to be DJML-controlled. In a further sample embodiment, that embedding takes place on a mobile handset or portable consumer electronic device in order to enable cross-fading to take place without resulting in excessive battery usage, something which is made possible only due to the standardised nature of the mark up disclosed by the preferred embodiment of the present invention.
The present invention may be used, in one example embodiment, to identify an item of digital media which forms a part of a fuller set—such as music that segues (segue: move without interruption from e.g. one song, melody, or scene to another). DJML allows, in the preferred embodiment, for those exception cases and may be used to define a seamless transition between them without the need to cross fade.
The present invention permits, in a further example embodiment, the identification of a musical piece that has a hard start and end. When played out of context, the DJML mark-up disclosed by the preferred embodiment of the present invention would instruct the client to treat such pieces in isolation and, in one example embodiment, to apply a fade to both ends.

### System Aspects

There is provided a system including a digital media player, a content delivery network and a content server, the digital media player connectable to the content server via the content delivery network, the content server operable to provide content delivery to the digital media player in response to calls to the content server from the digital media player, wherein the system is operable to

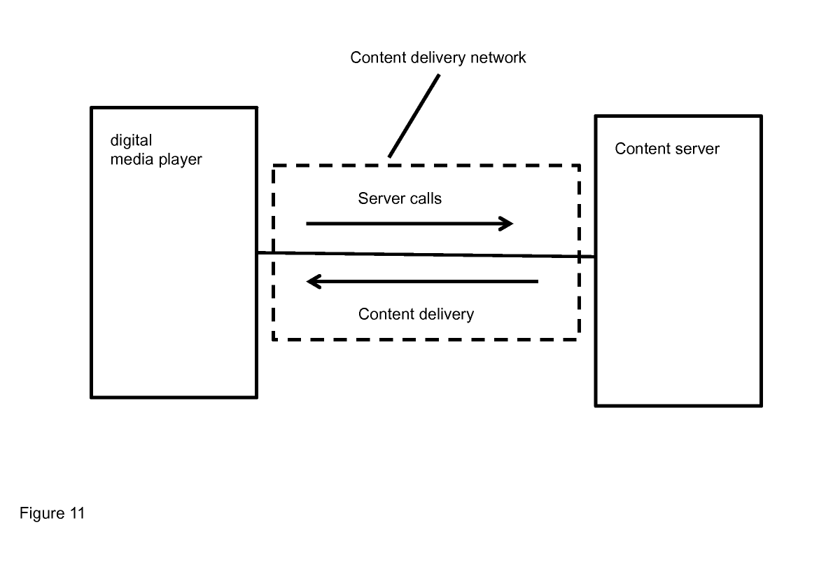

(a) identify a description which defines how to manage the playback of one or more items of digital media content, the description including descriptive metadata, and
(b) utilise the description within the digital media player to control automatically the playback of digital media content. See FIG. 11, for example.

The system may be one wherein the digital media player is operable to identify a description which defines how to manage the playback of one or more items of digital media content, the description including descriptive metadata. The system may be one wherein the content server is operable to identify a description which defines how to manage the playback of one or more items of digital media content, the description including descriptive metadata, and to transmit the description to the digital media player.

There is provided a system including a digital media player, a content delivery network, an identification server and a content server, the digital media player, the identification server and the content server connectable to each other via the content delivery network, the content server operable to provide content delivery to the digital media player in response to calls to the content server from the digital media player, wherein

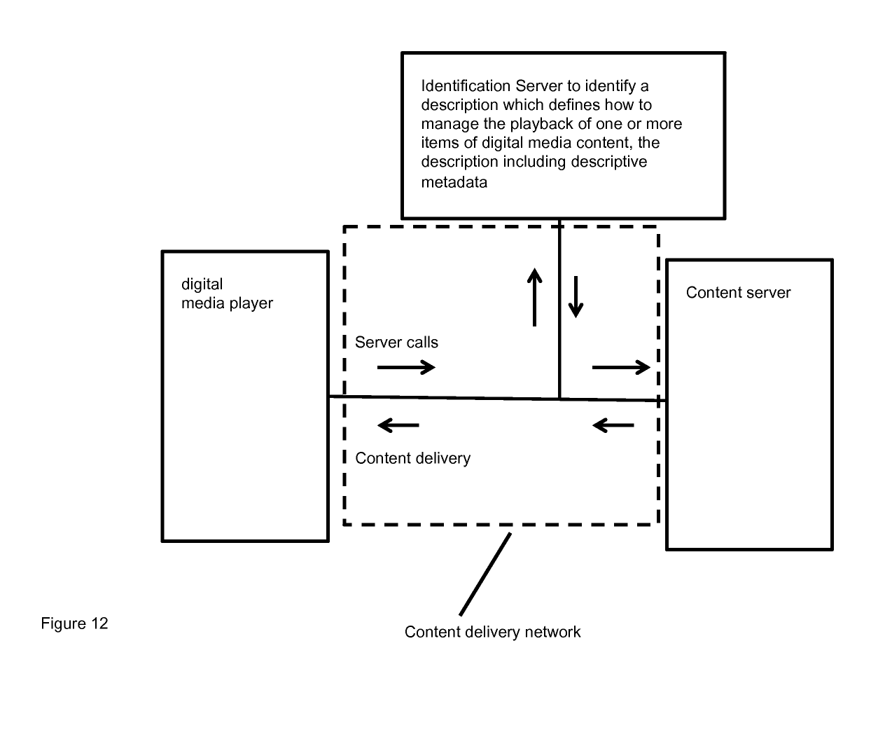

(a) the identification server is operable to identify a description which defines how to manage the playback of one or more items of digital media content, the description including descriptive metadata,
(b) the identification server is operable to transmit the description to the digital media player, and
(c) the digital media player is operable to utilise the description to control automatically the playback of digital media content. See FIG. 12, for example.

The content delivery network may be a wired network, a wireless network (eg a mobile phone network), or it may comprise wired and wireless components. The digital media player may be a mobile phone, a smart phone, a tablet computer, a desktop computer, a laptop computer, a dedicated digital media player, or a computer games machine. The network may be the internet, or a mobile phone network. The digital media player may be portable. The digital media player may include a touch screen. The digital media player may include a GPS positioning system. The system may include a plurality of digital media players.

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

### APPENDIX A

### Adaptive X-Fade Techniques

The following solutions assist us in providing an improved audio delivery in clients and platforms where we can control elements of the playback engine.

The solutions provided account for two elements of logic.

1. A Pre-Fetch of other tracks.
2. An Audio X-Fade solution that can cover all scenarios, including a solution that does not require a pre-buffer.

Both solutions require more than one audio player to be available.

Pre-fetch solutions work by requesting and buffering a piece of media ready for play. This means that the media is ready to play when it is needed. However we cannot fetch every potential and the solution simply applies to media in the play queue. It therefore is not a full solution in all use cases as a user may pick a new play source that cannot be predicted successfully.

The x-fade logic works to cover these other use cases and by balancing the play experience it obfuscates any perceived delays. In fact it is possible to achieve a good music user experience by only deploying the x-fade solutions.

The advantages of pre-fetching do vastly improve the experience as we have full control over the timing of the user experience.

### Audio X-Fade Solutions

The X-Fade solutions detailed here rely on the following:
Multiple audio players and the ability to play more than one player at any given time
Timed volume control
Variable volume control path shapes i.e. S-curve, linear etc
The ability to dynamically change the fade time and shape

There are solutions for the following use cases and also include an emergency intestinal solution that allows for notifications or error states by providing audio feedback.
Pause Play Pause
Play through to the next track in sequence (end to start)
Skip to next track
Skip back to last track
Skip back to start of track
Jump to position in playing track
Play from any other selection (not in sequence)

As for the rules that define the UX behaviour we have the following proposed solutions, for which the preferred is solution 2.
1. A system that fades down to a pre-defined point such as 50% or 25% of the original volume and waits until availability of the required media. If media is available a fast 2 second fade with a 1 second overlap is executed. This is known as ‘Fade to Hold’.
2. A system that fades to silence but expects to have the media ready within a set time (9-10 seconds) and when the media is ready a fast 2 second fade with a 1 second overlap is executed. This is known as a ‘Fade to Transition’.

The timings and values given here should be configurable allowing a service to be tuned to its requirement or user requirement. The times and values suggested here are a first assessment on how best to tune the system and need to be tested.

### Fade to Hold

When switching between Player 1 (Primary) and Player 2 (Secondary) a volume fade to zero should be carried out. The basic default rules should be as follows:

Start fade on user action
Fade to 25% over 2000 ms
Hold fade at 25% until next track player is ready to play
Continue to fade to 0% over next 2000 ms
Next track (pre-buffered player 2) should trigger 500 ms before the Primary Player finish it's fade and a Stop command is issued to Primary. (Secondary now becomes Primary)

### Fade to Transition

This system is the preferred approach. It gives a consistent feel to the execution, handles exceptions in a better and consistent manner.

There are essentially two types of volume control to execute.

### 1. Fast X-fade

Slow Fade, ready to X-fade

The fast X-Fade is a 2 seconds (2000 ms) linear volume adjustment from 100% of player volume to 0% with a X-fade/overlap of 1 second (1000 ms) for the next player. The effect is a perceived transition of 1 second.

The Slow Fade is a 10 second (10,000 ms) linear volume adjustment from 100% of player volume to 0%. If at any point in this process the next players media becomes ready then at that exact point the system switches to the Fast X-Fade (2 seconds, 1 second overlap). The effect here is that the volume control is executed at the user's action, and initially it begins a slow fade down and then adjusts the fade to a fast smooth X-Fade transition. It's like having a DJ fade down while listening to the ready state of the next song and only then executing the X-Fade at the right moment.

The new media coming in to play via the Pre-Fetch ready player should start at full volume.

This function will become adaptive later when we have segue flags for material that has an instant, mid-waveform start (i.e. segue tracks in the middle of album or live material). This ensures that segue material that is out of context has a smooth transition in (this transition should be a 2 seconds 2000 ms volume control fade-in from 0% to 100%).

In the preferred embodiment, this is configurable so that we can try short generic/global volume control fade-ins of short durations if it suits the tuning of the system.

If Pre-Fetch Player=ready (Fast X-Fade)
Then set volume transition time for Master Player to 2000 ms linear curve path
Start volume transition decrease on Master Player
1000 ms later start/play Pre-Fetched ready player (full volume)
Primary completes volume transition to zero
Else (Slow Fade)—when there is no media player ready to play (Pre-fetch)
Set volume transition on Master Player time to 10,000 ms linear curve path
When Pre-Fetch Player=ready switch to volume transition time to 2000 ms (Fast X-Fade)
There is an further volume control rule for Pause/Play

If the user pauses a playing piece of media (master player) then the player should action a volume control from 100% to 0% with an S-Curve fade shape over a time of 500 ms.

If the user plays a paused piece of media (master player) then the player should action a volume control change from 0% to 100% with an S-Curve shape fade over a time of 500 ms.

### Exceptions

It is possible that a piece of media is close to the end of its play time. A Slow Fade may then expose silence, it is unlikely that this scenario can be avoided and if the service is responding quickly then the transition should never be longer than 2 seconds.

If a user pauses the media and then skips then no special rules apply (unless a fade in has been designated as necessary or desired).

### Considerations

Does the user-controlled UI ‘Master Volume’ have an impact on the individual players ability to successfully execute a volume control change with sufficient granularity to ensure the quality of the X-Fade?
i.e. If the user had set the ‘Master Volume’ for a web client service at 10% is there sufficient granularity in the volume control change.
When preview points, points of interest, preview time points etc are added then the system can be set per service or per user choice to skip in to the most exciting part of media/song. From that point the media would continue to play until the user either skips to next, jump-to-start, jump-to-point or selects a new piece of media. The effect generated here is a system that plays the highlighted part of song and allows the user to keep playing from that point or to play the song from the beginning, it gives a far more powerful ability to hear the best of the music and to make decision making far easier and quicker.

### Slow Fade

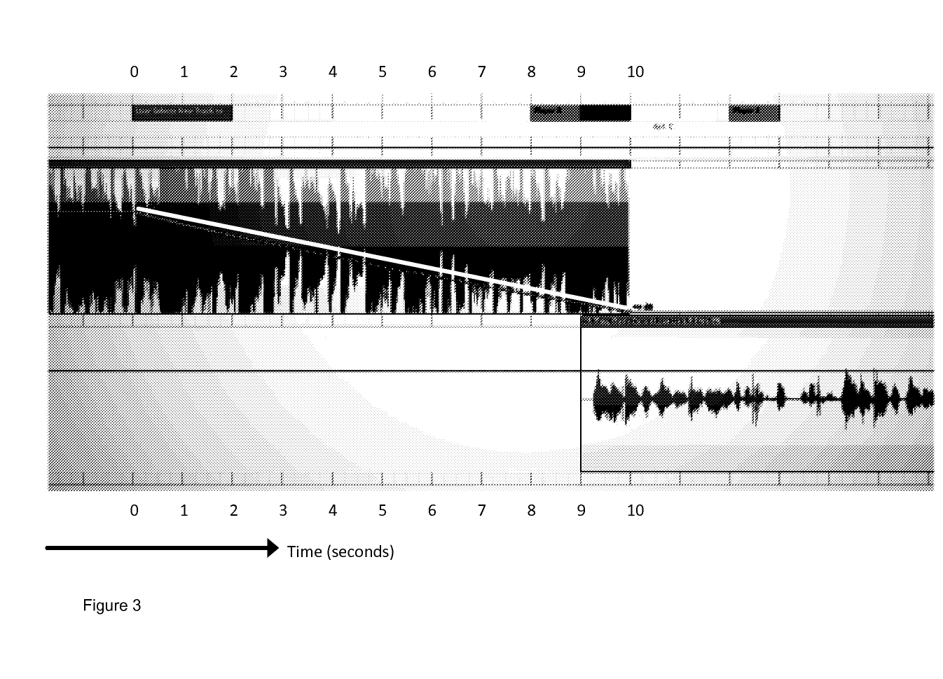

In FIG. 3 we can see that it took 8 seconds to get the Data Distribution Service (DDS), fetch the audio stream/file, buffer it and then transition it.

AN example of this use case is where the user clicked on a song that wasn't Pre-Fetched. If the DDS happened quickly we would see a switch from the Slow Fade to the Fast X-fade.

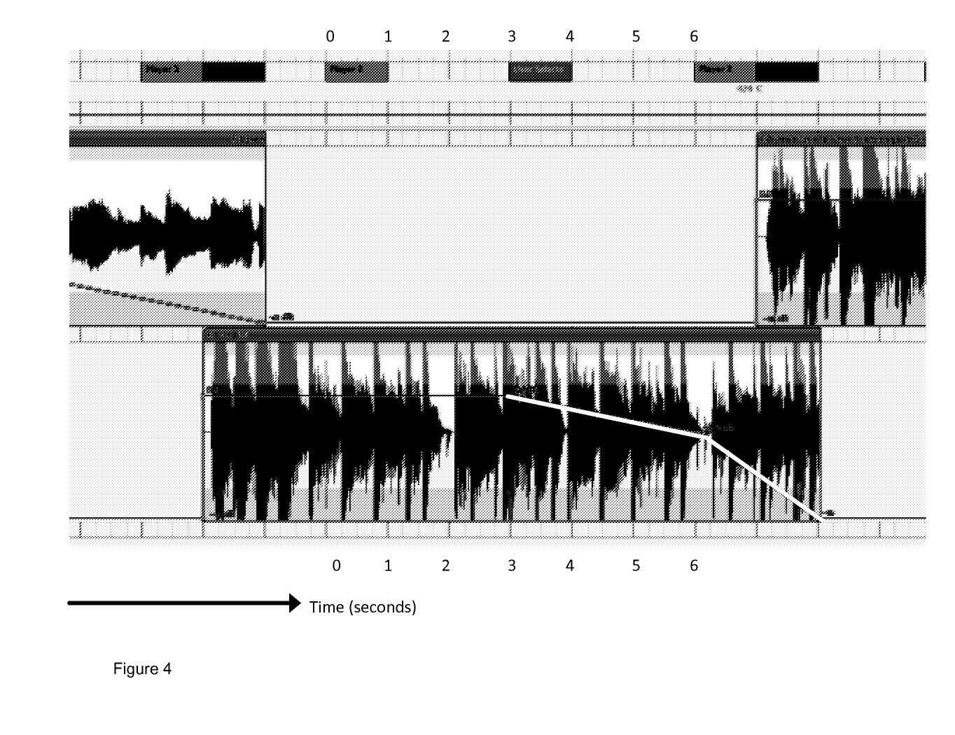

In FIG. 4 we can see that a song that was not Pre-Fetched took 6 seconds to retrieve and then switched to a fast transition.

### Additional Examples of Adaptive Audio X-Fades and Pre-Fetching Logic

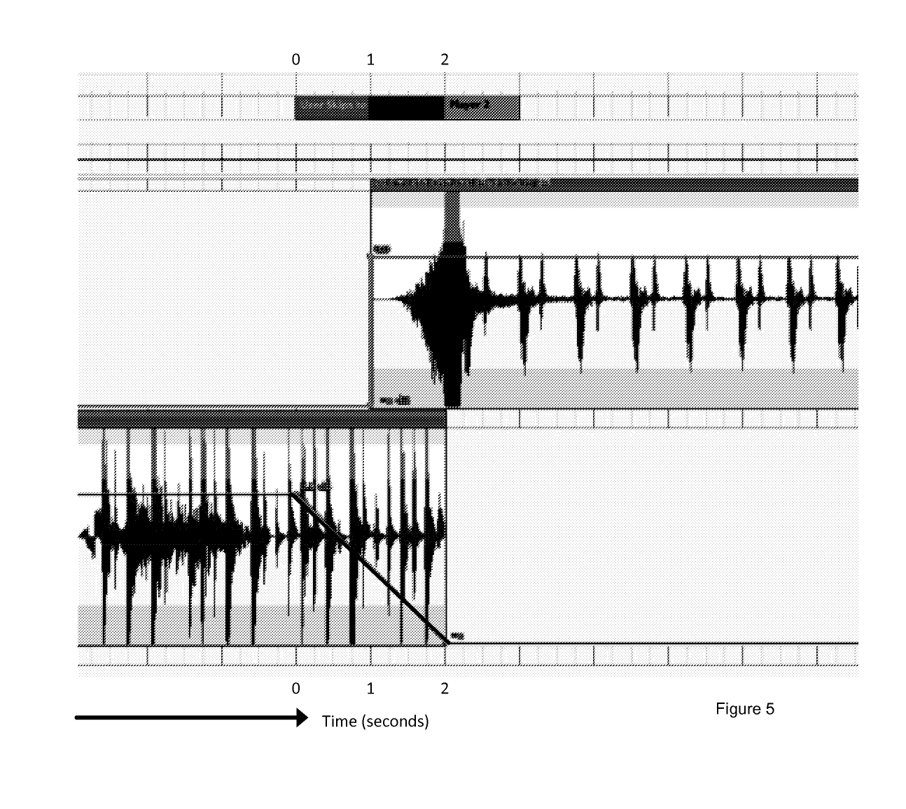

FIG. 5 shows a fast 2 seconds (2000 ms) Fast X-Fade. The next track in the sequence is ready and waiting as it has Pre-Fetched its contents. The fade is a linear fade and takes 2000 ms to complete. The new media is played at the 1000 ms point.

This creates a smooth transition while also obfuscating the blank audio at the front of almost all audio files.

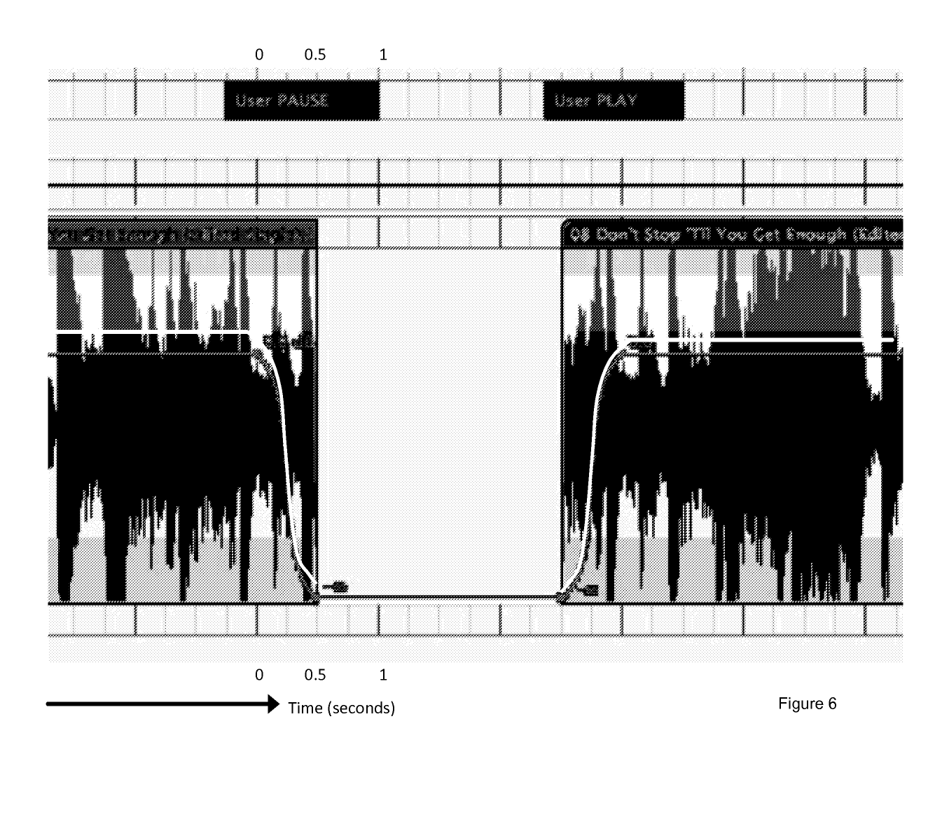

FIG. 6 shows a Pause and Play X-Fade that uses a 500 ms S-Curve fade to achieve a responsive and smooth experience.

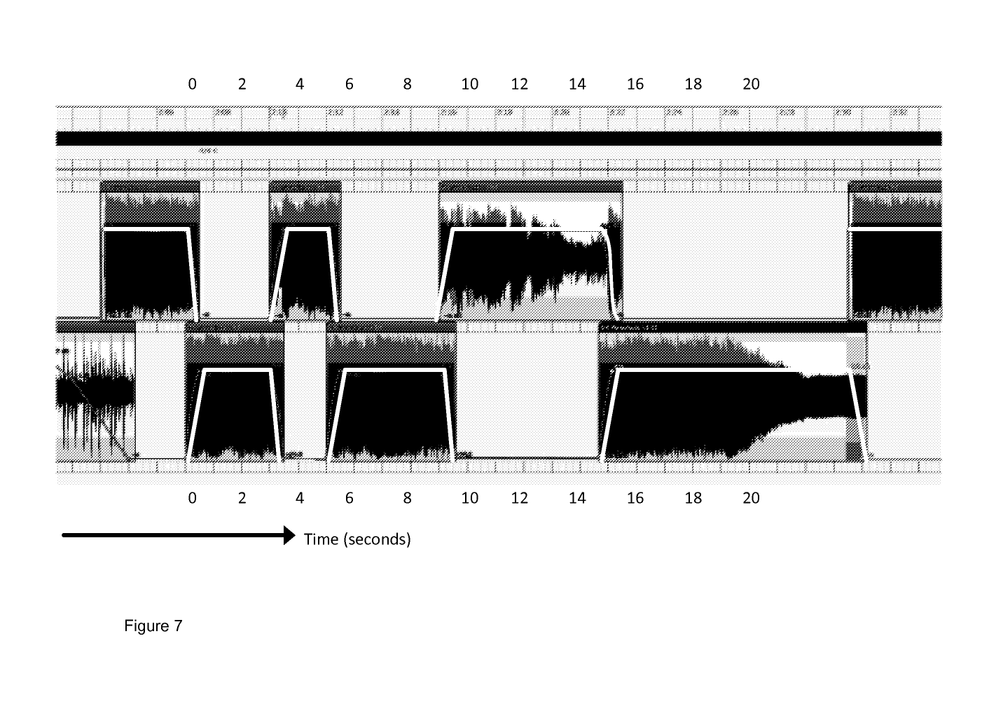

FIG. 7 shows two media players that are swapping the same audio stream as the user jumps about in the same piece of media. This is the ‘Seek’ experience or the Jump to Position architecture.

It uses a fast 500 ms true X-Fade (the media transitions at the point of execution) and employs an Equal Power X-Fade.

The user is playing the same song but they are jumping from point to point, possibly searching for their favourite bit or simply checking that this is the song they want.

The very last piece of audio on the right of the image shows the user executing a Skip Back (start media from the beginning). In this example no X-Fade is used to start the song again.

It is a very common use case for people who enjoy music to repeat the same song, the user experience here is that the repeating of the song is delivered in a smooth and professional manner. This in itself contributes to the playback and enjoyment of the music.

### APPENDIX B

### Using DJML in a Media Player

This appendix describes various use cases, as utilised in the preferred embodiment of the present invention, where DJML is used to control the operation of a digital media player to provide a seamless experience for the end user.

The disclosures below are intended to provide model examples only: any given example embodiment need not implement every single use case so described, nor need any given example embodiment implement the examples shown precisely as described.

### Player Start-Up

When opening a session/web player/software app there is no audio played until the user instigates a play action.

### Can it be Better?

Yes, an intro sound or song could be played.

This identifies the service.

Allows the user to know if the volume/headphones are working and set at the right level.

### Solutions:

Play a very short (3 second) streamed or pre-loaded file at start up.
Play an interstitial or piece of audio that is used to brand the service.
User selects a song clip to start the service with.
The service starts playing at the last play point that they were in when they last exited (based on last play state?).

### Execution:

Begin with an audio fade-in (volume control from 0% to 100%) over 5-10 seconds (definable in the platform/service).
Or start at 100% (dependant on the audio i.e. an interstitial that has a ‘baked in’ fade in).

### User Skip (Forward and Back in the Play Queue)

When a user skips a track in the play queue/sequence/line-up/album/playlist using the play controls [>>] or [<<] to the next

There are several iterations of this use case as follows:
Skip forward to next track
Skip forward to a track in the play queue beyond the next track
Skip back to the last track
Skip back to a track in the play queue history beyond the last track

### Problem:

There is a delay and therefore a silence while the next track is requested, received, buffered and played.
There is a small (between 0-500 ms average ‘guess’ is about 400 ms) piece of blank audio at the front of most audio files.
Where a piece of music starts (fades) quietly this silence can be perceived as much longer (up to a several seconds).

### Can it be Better?

Yes, it would be a quantum leap to remove this audio silence.

### Solutions:

Pre-Fetch the next track.
Pre-Fetch multiple tracks (1 back and 3 forward).
Volume control and/or cross fade (additional audio players).

### Exceptions:

We cannot Pre-Fetch outside of the immediate play queue/sequence.
We cannot Pre-fetch in any other use case (i.e. select a song from anywhere else).
However the Audio X-Fade does cover these scenarios.

### Execution:

See section on Pre-Fetch and Audio X-Fade logic (including logic for arranging players during transitions).

### User Skip Back to Start of Current Song

When a user skips back [<<] during a song playing or paused then the song returns to the beginning. During the first 5 playing seconds of the song this action would simply jump to the previous track in the play sequence.

### Problem:

There is a small delay (very small) and a potential harsh stop (if the beginning of the song has a gap of audio).
There is a small delay here, a very small delay mind you because the stream is active and the player is receiving the active DDS track from the content delivery network (CDN).
There is a situation where a large song may not have been fully cached on the CDN and therefore a very long delay could be perceived.

### Can it be Better?

Yes, it would be nice to keep the overall audio experience the same by eliminating every use case and this is a small one but we can achieve it.

### Solutions:

Use the last (5th or Pre-4) player to stream the beginning of the track again from a new player.
Using a fast (500 ms) X-Fade to ‘blend’ the transition.

### Execution:

See section on Pre-Fetch and Audio X-Fade logic (including logic for arranging players during transitions).

### User Change Selection

When a user selects a piece of music from a search result, from a channel, a playlist, from an artists selection or any other situation where it is outside the play queue/selection/line-up that is not already Pre-fetched.

### Problem:

A harsh stop is experienced in all existing music services under this use case.
A delay is experienced while the client sends and waits for a request for a song.
This delay could be quite large dependant on the CDN availability, network connection or user home bandwidth.

### Can it be Better?

100% Yes, it would be a quantum leap in music services to be able to smooth out this scenario by balancing the experience between the delivery delay and the audio blend with a X-Fade.

### Solutions:

Use the Audio X-Fade solutions here.
Focus on speeding up the CDN performance.

### Between Songs in a Queue

When a song finishes playing and another starts there is a small gap while the next song is fetched, buffered and played. Use cases are as follows:
Between one un-associated song and another (playlist, channel, search results, artist results etc)
In a pre-existing sequences (albums). Segue needs to be considered here.

### Problem:

There is a variable delay in fetching the next track in the list/play queue.
This varies between territories.
This varies depending on user's network performance.
This varies depending on the availability of the request cached state.
There is often a large audio gap at the end (Tail) of (2-7 seconds or more in some cases) and a smaller gap at the front of (Top) that contributes in a large way to this perceived gap.
Segue songs do not blend perfectly in to each other.

### Can it be Better?

Yes, optimisation of the platform performance, pre-fetching the next track and smoother transitions to cover the gap.
Having gapless playback fixes the segue scenario.
Removing the audio silence gaps at the top and tail of a track.

### Solution:

Pre-fetch the next track in the play queue.
Potentially pre-fetch the next x number of tracks in the play queue.
Utilise data that indicates the actual start and end times of audio within the audio file frame work (silence at front of track and silence at end of track) to reduce this gap of silence.
Use a X-Fade of either a fixed 5 seconds or a variable user set rate to blend the transitions.
Use an adaptive timed X-Fade that is driven by the fade out of the end of one song and the start velocity of the next track . . . or driven by tempo, genre etc.

### Execution:

Flag music that is part of a segue collection and ensure that those songs, when played in sequence maintain a gapless playback by timing the two media players.
Find the gaps at the front (Top) and the end (Tail) of the media catalogue and reduce these silences.
Where there is no segue then ensure that an audio X-Fade should link the songs together, either with a standard Fast X-Fade or a service/user set X-Fade (i.e. 1-12 seconds).

### Pause/Stop—Pause/Play

When a user pauses the media from a play state or un-pauses (plays) the media from a pause state.

### Problem:

A harsh stop is often experienced, this is more of a problem at loud volume settings.

### Can it be Better?

Yes, a smoother transition would add a subtle but polished feel to the service and the user interface.

### Solution:

Employ a fast and smooth volume control (fade out and fade in).

### Execution:

On a user pause action reduce the volume from 100% to 0% over 500 ms using an S-Curve shape. Do the opposite for an Play from Pause action.
We should allow for a roll back scenario, this is where the audio play point on a play (resume from pause) action is −500 ms from where it was initially paused. This compensates for the missed piece of music and timing that may be lost during the pause process. (We should make this configurable as 1000 ms may suit this better).

### Seek (Fast Forward and Rewind)

When a user ‘seeks’ or jumps to position in a playing piece of media (using the time line or other mechanism) the media stream moves to the new position.

### Problem:

There is a small (often tiny) delay as the stream data is requested at the new position.
There can be a large delay if the media is not ready in the CDN for the new position.
There can be an abrupt change that takes place in the listening experience.

### Can it be Better?

Yes, it would be nice to keep the overall audio experience the same by eliminating every use case where silence is evident and this is a small one but we can achieve a far better user audio experience.

### Solutions:

Use the last (5th or Pre-4) player to stream the new media position.
Using a fast (500 ms) X-Fade with an S-Curve shape to ‘blend’ the transition.

### Execution:

See section on Pre-Fetch and Audio X-Fade logic (including logic for arranging players during transitions).

### Exceptions or Considerations:

The alternative (Pre-4) player being made available for this action might need to request the same stream so that it is ready to play the new media at the new position. (We may find that this is not needed and the alternative (Pre-4) player may simply just need to request the active stream).

### End of Play Queue

At the end of a play queue or sequence the media will stop playing (unless in a repeat mode).

### Problem:

No problem . . . this is an expected state to be in.

### Can it be Better?

Yes, an background sound or song could be played.
This identifies the service.
Allows the user to know that the sequence has stopped and they might want to select some more media.

### Solutions:

Play a very short (3 second) streamed or pre-loaded file after the media sequence has finished.
Play an interstitial or piece of audio that is used to brand the service.

### Error

When there is a system error due to any of the following situations (or others as yet undefined) an uncontrollable or unexpected situation occurs. In the world of information or visual presentation we often have notifications or feedback as to what is happening. This is currently missing from the world of audio.

The system/service may well recover in a few seconds. The following solutions allow the client to re-try.
Sever maintenance.
CDN error.
File error.
ISP error.
Bandwidth problem.
Delay in CDN/server.
User connection problem.
Playing media has not cached/buffered the full song when any of the above occurs.

### Problem:

The media stops . . . either the sequence fails to complete or the current playing media stops mid-way through due to an error.

### Can it be Better?

Yes, we can anticipate a media delivery error because there will be enough of the media buffered that we can execute a solution.
Allowing the user to be able to hear that a problem has taken place is a better experience than silence.
Error interstitials could be branded or full of polite customised audio that breaks the bad news to the user.

### Solutions:

Play a pre-loaded interstitial.
Fade the audio out ahead of the last buffered audio before triggering a an audio X-Fade into an error state interstitial.
A fade back in would occur when enough buffer was filled to resume playback.
See the section on Pre-fetch that allows for a similar system during long wait times beyond 10 seconds.

### Exceptions:

It is possible that some logic is required to avoid a situation of ‘histrionics’ where a bad connection or problem results in the media almost reaching the end of its buffer (ahead of its natural end point) which could trigger a fade out, followed by resumption repetition event. I would suggest that a longer buffer time was set before resuming again within a single piece of media to avoid this (doubling of the buffer wait to fill time each time this takes place)

### APPENDIX C

### Method, System and Computer Program Product for Navigating Digital Media Content

### Summary

According to a first aspect, there is provided a method for presenting a user interface to an end user to facilitate the searching, browsing and/or navigation of digital media content, the method comprising the steps of:

(a) analysing the digital media content to create “hooks” related to the digital media content, or retrieving “hooks” in the digital media content, and
(b) replacing or augmenting a graphical or textual representation of the digital media content with the “hooks.”

The method may further comprise:
one comprising the step of: presenting the “hooks” to the end user, so that the end user can search, browse and/or navigate the digital media content using the “hooks”.
one comprising the step of: providing a unifying sound in the background to conceal any silent holes or gaps in playback.
one where the unifying sound is played in the background to conceal any silent holes or gaps in playback and/or to provide a consistent aural cue that the audio user interface is in operation.
one where the unifying sound consists of a hum, a crackling sound, white noise, audience sounds, a station identification signifier, or any other audio and/or video content.
One in which the “hook” consists of one or more extracted sections of a track of audio and/or video content which are identified as (i) being representative of that track as a whole; or (ii) being the most recognisable part or parts of that track; or (iii) being the “best” parts of that track, however defined; or (iv) being related to one or more portions of another track, including but not limited to such portions of a track as are similar to portions of other tracks, such as tracks which start in a similar manner, however defined; or (v) being evocative of that track, however defined; or (vi) a combination of one or more of the listed criteria.
One in which the “hook” is identified using one or more of digital signal processing (“DSP”) technology, manually or by any other method.
One in which the “hook” consists of one or more hooks from one or more tracks (“per-track hooks”), such individual hooks being combined to constitute a single hook by means of one or more of cross-fading, juxtaposition or any other technique to combine digital media content.
One where the decision as to which method to utilise when combining multiple per-track hooks into a single hook is determined by DSP analysis of the individual tracks and/or the individual per-track hooks.
one where a set of tracks may be previewed by means of the playback of a hook for that set, that hook being created by combining the per-track hooks of the tracks which constitute that set of tracks.
one where the said set of tracks consists of tracks in a playlist, a set of search results, a group of tracks formed according to metadata or any other grouping of tracks.
one where the metadata using to form a group of tracks consists of one or more of the artist, performer, genre, year of release or re-release or creation of tracks, the release or album on which the track or tracks appear, the popularity or tracks within a given group of users of a service or any other metadata recorded about tracks.
one where the playback of a hook for a track or a set of tracks is triggered by an action performed by the user of a service.
one where an action performed by the user of a service triggers the playback of the per-track hook of a subsequent track while the current track continues playing, where the said hook is faded in and then out while the current track continues playing or where the current track is paused during playback of the hook or where the currently playing track is replaced by the hook for the duration of the hook, whether or not the currently playing track restarts again subsequently, or by any other means.
one where the decision as to how to play a hook is made using DSP processing to determine the volume at which the hook is played and/or the playback technique employed so as to ensure that the hook is clearly audible without being intrusive, according to parameters defined for a particular service, device or user.
one where an action performed by the user of a service during playback of hook is able to trigger playback of the track from which a particular per-track hook is derived.
one where playback of the said track commences at the start of that track, at the point of that track from which the hook was extracted or from any other point.
one where the said action consists of one or more of a mouse click on a graphical user interface element, a tap on a specified region of a touch-sensitive interface, a specific keyboard command, a specific vocal command, a specific gesture identified via a mouse, a touch-sensitive or motion-sensitive interface or any other machine-recognisable action.
one where hooks for tracks and/or sets of tracks are played in the background while the user is browsing said track or sets of tracks.
one where playing audio and/or video content in the background consists of one or more of cross-fading between hooks, including but not limited to per-track hooks; or playing hooks at a lower than usual volume; or playing hooks using 3D Audio Effect techniques such that the sounds appear to originate from a specific location, such as behind or to the side of the listener; or any other method or combination of methods designated as signifying that the hooks are being played in the background.
one where the user of a service is able to browse tracks or sets of tracks by browsing the hooks for those tracks or sets of tracks in addition to, or in the place of, browsing via a graphical and/or textual interface.
one where, in addition to the playback of hooks, audio narration replaces or augments any or all other visual elements of a graphical interface to enable access to a service by blind or partially sighted individuals.
one wherein the method is for presenting an audio user interface (“AUI”) to an end user.
one wherein the “hooks” include audio “hooks”.
one wherein the method is applied in a system comprising a display, a speaker and a computer, the computer configured to display the graphical or textual representation of the digital media content on the display, and the computer further configured to output the “hooks” using the display and/or the speaker.
one wherein the display comprises a touch screen.
one wherein the system is a personal, portable device.
one wherein the personal, portable device is a mobile phone.
one wherein the system includes a microphone, and the computer is configured to receive voice input through the microphone.
One wherein the system is operable to receive a user selection of digital media content.
one wherein the digital media content is digital music content.
One wherein the digital media content is digital video content.
one wherein the digital video content is movies, or television shows or computer games.

According to a second aspect, there is provided a system comprising a display, a speaker and a computer system, the computer system configured to display graphical or textual representation of the digital media content on the display, the computer system further configured to output “hooks” relating to the digital media content using the display and/or the speaker, the system operable to present a user interface to an end user to facilitate searching, browsing and/or navigation of digital media content, the system further operable to:

(a) analyse the digital media content to create the “hooks” related to the digital media content, or to retrieve the “hooks” in the digital media content, and
(b) to replace or to augment the graphical or textual representation of the digital media content with the “hooks.”

The system may be operable to implement the methods according to the first aspect.

According to a third aspect, there is provided a computer program product, which may be embodied on a non-transitory storage medium or on a cellular mobile telephone device or on another hardware device, the computer program product operable to perform a method for presenting a user interface to an end user to facilitate the searching, browsing and/or navigation of digital media content, the method the comprising the steps of:

(a) analysing the digital media content to create “hooks” related to the digital media content, or retrieving “hooks” in the digital media content, and
(b) replacing or augmenting a graphical or textual representation of the digital media content with the “hooks.”

The computer program product may be operable to implement the methods according to the first aspect.

There are disclosed herein mechanisms for presenting an audio user interface (“AUI”) to an end user to permit the navigation of digital media content without relying entirely on graphical mechanisms to do so.

For simplicity, the AUI disclosed is presented in terms of an audio interface for navigating a music catalogue. However, similar and identical techniques to those which are disclosed below may also, in a further example embodiment of the present appendix, be used to produce an interface for navigating a catalogue of video—such as movies, television shows or computer games—or any other appropriate digital media content.

### Detail

### The Audio User Interface

Several elements of an Audio User Interface are disclosed below. Any single such element may be sufficient alone to constitute an embodiment of the present appendix though a preferred embodiment utilises each element disclosed below.

### The Hook

A core component of the AUI (“Audio User Interface”) is that of the “hook”.

A “hook” is a piece of audio, video or both which is identified within a piece of digital media content as being representative of that content, whether that be representative in the sense of being evocative of that content or of being a particularly identifiable or recognisable area of that content.

For example, the opening bars of Beethoven's Fifth Symphony would be considered an identifiable “hook” for that piece, while a short segment of vocals or a particular riff or other sequence from a popular music track (such as Lulu's cry of “Weeeeeeelllllll” at the start of “Shout”, for example, or a specific riff from the middle of Michael Jackson's “Thriller”) might similarly constitute “hooks” for those pieces. Similarly, one or more scenes of a movie or television show or a sequence recorded from a computer game may be identified as “hooks” for those items of digital media content (examples of such video “hooks” may commonly be found in trailers for those pieces of content).

A variety of ways of identifying such “hooks” exist in legacy technologies, including both manual identification of hooks and their auto-detection via DSP, digital signal processing, technologies, whether pre-existing or developed or customised for use in concert with examples of the present appendix.

However identified, a given piece of digital media content may feature one or more “hooks” which may then be utilised within the Audio User Interface (AUI).

Hooks are typically short pieces of audio/video content, often no more than 10 seconds in duration and, in a preferred embodiment, approximately 1 to 6 seconds in duration.

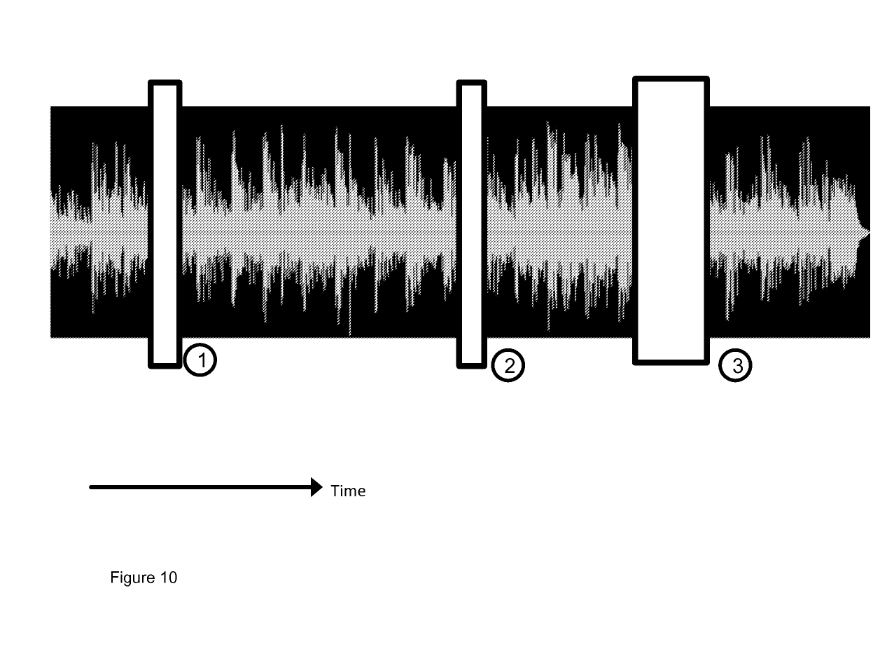

FIG. 10 illustrates a waveform where several hooks have been identified, and marked graphically. In the example, point 1 indicates the start of the vocals, point 2 is an identified riff which is evocative of the tenor of the piece and point 3 is a section of the content which is recognisably memorable. How each hook was identified in FIG. 10 is not important for the purposes of the present appendix—it is important only that such hooks can be identified for use within the AUI, whether automatically or manually marked as points in the track.

Hooks in a digital content file may be identified for example by identifying portions of the digital content file in which there is the biggest change in tempo, sound volume, musical key, frequency spectral content, or in other ways, as would be clear to one skilled in the art.

### Browsing Sets of Tracks Using Hooks

A set of tracks—such as a playlist, a set of search results, a channel (as disclosed in WO2010131034(A1), which is incorporated by reference), the favourite tracks of a given user or group of users, an album or release, the discography (in whole or in part) for a given artist, user-selected tracks, recently released tracks, forthcoming tracks or any other group of tracks—may be browsed in the context of examples of the present appendix by triggering playback of the hooks of the tracks within that set.

In a preferred embodiment of the present appendix, a set of tracks may be “previewed” by playing the hooks of each of its constituent tracks consecutively.

Each such hook may be cross-faded into the next, in one example embodiment, to form an apparently seamless audio sequence which provides a clear indication of the nature of that set of tracks. In another example embodiment, the hooks are simply played consecutively, with no gaps between hooks and with no cross-fading. In still another example embodiment, hooks are played consecutively with gaps, typically of very short duration, between each hook. In a preferred embodiment, DSP processing of each hook is used to identify which transitioning or “cross-fading” technique to utilise in each case.

In a preferred embodiment, the user experience is exemplified by hovering the mouse cursor (or making a finger gesture, in the case of a touch interface; or a vocal command, in the case of a vocal interface or by some other triggering mechanism, as disclosed below) over a playlist and thus triggering the playback of the hooks for the tracks within that playlist, each hook cross-fading into the next to provide the user with an overall “feel” for that playlist's contents. At any point, commands—such as single- or double-tap of a “Play” control—may be used to trigger playback of the entire playlist or of the specific track associated with the currently playing hook. Details of such commands are also disclosed below.

Where a set of tracks is browsed while a track is playing then the set of “hooks” are, in a preferred embodiment, treated in the same way as hooks for individual tracks, using the techniques disclosed below.

### Browsing Tracks Using Hooks

Browsing tracks from within the Audio User Interface (AUI) relies on the use of hooks to provide the user with usable cues as to nature of the audio content being browsed.

In a traditional GUI (Graphical User Interface) it is possible to browse groups of tracks—such as forthcoming tracks, selected tracks or search results—by navigating a list of track titles or artwork. That interface does not, however, provide any clues as to the nature of those forthcoming tracks: In order to check what a track sounds like, it has been necessary to play it explicitly to a point where that track or its style becomes recognisable.

By contrast, the AUI allows forthcoming tracks to be checked, even while listening to a currently playing track if desired. In a preferred embodiment, this is accomplished by fading down the currently playing track (if any) and fading in the hook for the forthcoming track before fading back to the currently playing track (“cross-fading” between the track and the hook and back again). In a preferred embodiment, such “cross-fading” is performed using techniques disclosed in Omnifone Patent Application nos. GB1118784.6, GB1200073.3 and GB1204966.4, which are incorporated by reference.

By utilising the hook of the forthcoming track only, the “flavour”—mood, genre, tempo, suitability, etc—of that track may be sampled by the user without having to listen to the entire track. And since that sampling is performed aurally, rather than merely by viewing the track title, artwork or a text description of it, then the user is more readily able to make a decision as to whether or not he wishes to listen to that entire track even without having heard it before.

In another example embodiment, the currently playing track (if any) is effectively paused while the “hook” for the forthcoming track is played, and is restarted after that hook has been played. In still a further example embodiment, the hook is not cross-faded but is simply inserted in place of the currently playing track. In still a further example embodiment, the currently playing track continues playing and the hook is played simultaneously with that track, whether cross-faded in or played at a different volume or by using some other technique to differentiate the hook from the currently playing track.

In yet a further example embodiment, the technique used to play the hook is chosen dynamically based on Digital Signal Processing of the currently playing track and the hook. In this latter case, a loud hook played during a quiet segment of a currently playing track might be played more quietly and the currently playing track not reduced in volume, which the converse case—a quiet hook played during a loud section of a currently playing track—might, in one example embodiment, result in the track volume being reduced as the quieter hook is played, whether by cross-fading or otherwise.

In a preferred embodiment, if there is no currently playing track then hooks may be played directly, and—in a preferred embodiment—cross-faded such that each hook cross-fades into the next. In another example embodiment, no such cross-fading takes places and each hook is simply played consecutively.

Selecting a Track from a Set of Tracks

In a preferred embodiment, when playing a hook then a user-initiated trigger may be used within the AUI to cause the track from which the currently playing hook is derived to be played.

In one example embodiment, that user-initiated trigger is a traditional button, such as the “Play” button in a GUI or a control panel. In another example embodiment, that trigger is a vocal command, eye movement or a visual gesture. In still another example embodiment, that trigger is the hovering of a mouse cursor over a visual indicator. In yet another example embodiment, that trigger consists of a mouse or finger gesture on an item in the user interface. In a preferred embodiment, the appropriate trigger is accessible depending on the hardware available and the user or system preferences configured.

When triggered for playback, a preferred embodiment will play the remainder of the track from the “Hook” section onwards, omitting playback of the earlier portion of that track (“Behaviour A”). In another example embodiment, that trigger causes the hook's track to play from the start of that track, whether cross-fading from the hook to the start of that track or not (“Behaviour B”). In still another example embodiment, the behaviour is user-configurable by, for example, setting a user preference for Behaviour A or Behaviour B.

In a preferred embodiment, clicking the Play button causes Behaviour A while clicking that same button twice causes Behaviour B. In another example embodiment, some other mechanism is employed to permit user-selection between Behaviour A and Behaviour B.

### Browsing Tracks

In a preferred embodiment, if no track is currently playing but the user is nonetheless browsing through tracks or sequences or tracks, such as playlists, then the hooks of browsed digital media items playback in the background. In a preferred embodiment, “in the background” indicates at a lower volume to that at which the audio would normally be played and/or partially transparent or otherwise unobtrusive video playback and/or the use of 3D Audio Effect technology to place the apparent origin of audio at a specific point, such as behind or to the side of the listener. In another example embodiment, “in the background” does not affect the volume or transparency or apparent spatial origin of the playback of the hook for the track being browsed.

Browsing tracks and sets of tracks may, in one example embodiment, be carried out by the end user by moving a mouse cursor or a finger between icons indicating tracks or sets of tracks, triggering the playback of hooks of those tracks to cross-fade in synchronisation with the movement of that cursor. In another example embodiment, eye tracking is used to control the cursor movement across the interface. In still another example embodiment, the cursor is controlled by other mechanisms, such as via vocal commands or by using the tilt control of a motion-sensitive device.

In a preferred embodiment, while browsing the user may select a track to play in full in the same manner as disclosed above, such as by pressing “Play” while a particular hook is playing.

In that case, in a preferred embodiment, the track associated with a given hook will become the currently playing track and all other behaviour of the AUI continues as disclosed above.

### Slideshow Accompaniment

In one example embodiment, hooks for tracks are collected together based on some preset criteria, such as mood or genre, and played as ambient music in their own right. In another example embodiment, images—whether still or video—are similarly selected using the same or similar or, in still another example embodiment, different criteria.

The imagery and the sequence of musical hooks are then played simultaneously to form an ambient slideshow with audio accompaniment.

In a preferred embodiment, a pre-chosen set of images is analysed by DSP to determine its overall “mood” or other desired style and a sequence of audio hooks with similar moods is generated, again via DSP identification, to form an audio accompaniment to that imagery.

### A la Carte Purchasing

In a preferred embodiment, playback of each hook is accompanied by a link or button via which the user is able to purchase the rights to play the track associated with that hook on one or more of that user's media player devices.

### Unifying Sound

In a preferred embodiment, a low level background sounds, such as a hum or a faint crackling sound—is utilised throughout the AUI in order to conceal any silent holes or gaps in playback and/or to provide a consistent aural cue that the AUI is in operation.

### Accessibility

By providing an audio interface, the AUI facilitates greater accessibility for blind or partially-sighted users.

In a preferred embodiment, those user interface components which are visual and which cannot be replaced by the AUI as disclosed above are accompanied by mark-up to permit them to be rendered using vocal narration and/or on Braille screens. Also in a preferred embodiment, any such audio narration is treated as the “currently playing track” for the purposes of the present appendix disclosed above, with the playback of hooks being performed in such a manner as to permit that narration to continue to be clearly audible. For example, by allowing hooks to be played “in the background”, as disclosed above, below the audio narration while browsing and/or during playback.

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. A method for managing playback of one or more items of digital media content, for example to ensure naturalistic transitioning between items of digital media content, comprising the steps of:
(a) identifying a description which defines how to manage the playback of one or more items of digital media content, the description including descriptive metadata, and
(b) utilising the description within a digital media player to control automatically the playback of digital media content.

2. The method of claim 1, in which the description for a specific item of digital media content includes metadata that identifies significant events or characteristics of that item and in which the digital media player then automatically uses that metadata to control the playback of that item.

3. The method of claim 2, in which the description for a specific item of digital media content is a timeline description that identifies when in time significant events in the item occur or the location of those significant events.

4. The method of claim 1 where the descriptive metadata about a digital media content file comprises one or more of the start point of actual content in a file; the end point of actual content in a file; the region or regions of the file which constitute vocals; the tempo of the media content; the mood of the media content; the pitch of the media content; “hooks” within the content; suitable fade in and fade out points; the positions of any choruses within the file; the locations and types of any beat points in the file; any overlay positions at which other content may be overlaid onto the digital media content during playback; and any other metadata which is relevant to controlling the playback of a digital media content file.

5. The method of claim 1 where the descriptive metadata about a digital media content file is identified by applying Digital Signal Processing (DSP) technologies to the digital content file or is identified manually or is identified by a combination of both automated and manual processes.

6. The method of claim 1 further including the step of creating a description defining how to manage playback, and that step is performed automatically or utilises a tool or tools created for that purpose or is performed manually or is performed by a combination of the listed approaches.

7. The method of claim 1 where the description of how to manage playback includes one or more of a representation of the descriptive metadata about the digital media content, including but not limited to one or more of the start point of actual content in a file; the end point of actual content in a file; the region or regions of the file which constitute vocals; the tempo of the media content; the mood of the media content; the pitch of the media content; “hooks” within the content; suitable fade in and fade out points; the positions of any choruses within the file; the locations and types of any beat points in the file; any overlay positions at which other content may be overlaid onto the digital media content during playback; and any other metadata which is relevant to controlling the playback of a digital media content file.

8. The method of claim 4 where the “hook” comprises one or more extracted sections of a track of audio and/or video content which are identified as (i) being representative of that track as a whole; or (ii) being the most recognisable part or parts of that track; or (iii) being the “best” parts of that track, however defined; or (iv) being related to one or more portions of another track, including but not limited to such portions of a track as are similar to portions of other tracks, such as tracks which start in a similar manner, however defined; or (v) being evocative of that track, however defined; or (vi) a combination of one or more of the listed criteria.

9. The method of claim 4 where the “hook” is identified using one or more of digital signal processing (“DSP”) technology, manually or by any other method.

10. The method of claim 4 where the “hook” comprises one or more hooks from one or more tracks (“per-track hooks”), such individual hooks being combined to constitute a single hook by means of one or more of cross-fading, juxtaposition or any other technique to combine digital media content.

11. The method of claim 1 where the description of how to manage playback includes information concerning one or more of recommendations of requirements concerning how a digital media content file may be cached on a client device; “fallback” digital media content which may be played in place of the said digital media content file should that file be unavailable for any reason; recommendations or requirements as to which digital media content should be played after the said digital media content file; how to play the digital media content, in terms of which audio and/or video processing to apply, which initial volume to use for playback, how to apply normalisation of tracks or any other playback criteria; how to overlay, whether optionally or otherwise, one track onto another, such as defining commentary tracks of audio, video or text for presentation alongside a currently playing track; how to manage playback, including information concerning how to control the tempo and/or pitch of digital content during playback; any other types of sound processing to employ during playback, such as one or more of effects, equalization, volume normalization, compression or any other audio and/or video processing; how to manage the presentation of the digital media content to the end user in the client's user interface; and any other metadata which is relevant to controlling the playback of a digital media content file.

12. The method of claim 1 where the description of how to manage playback includes technical information concerning one or more of how to manage the transition between two or more items of digital media content, including one or more of when to start and end the transition in the first file; when to start and end the transition “end point” in the second file; which transition effect or combination of transition effects to utilise; the duration for which to apply any such transition effects; which interstitials, if any, to utilise when transitioning from the first digital media content to the second; and any other metadata useful to defining the transitioning between digital content files.

13. The method of claim 12 where the transition effect comprises one or more of linear, s-curve or parametric fading, fade-to-hold, fade-to-transition, slow fade, cross fade, fast cross fade, the timing of the effect, the duration of the effect or any other information relevant to applying a given transition effect.

14. The method of claim 1 where automatic creation of the description is performed by a software application which generates a representation of an item of digital media content using descriptive metadata identified about that content to generate a description in some standardised format, such as XML, JSON or any other applicable format.

15. The method of claim 1 where the description defining how to manage playback describes a sequence of one or more items of digital media content, defines any effects to apply during playback and how to manage the transition between each item of digital media content.

16. The method of claim 15 where the said description is created using a software application which generates the said description from a manually or automatically provided list of digital media content files or excerpts from such files such that the said description generated in some standardised format, such as XML, JSON or any other applicable format.

17. The method of claim 1 where a digital media content file itself includes a description which defines how to manage playback of one or more items of digital media content.

18. The method of claim 1 where a digital media content file includes one or more excerpts from one or more digital media files and/or more than one digital media file.

19. The method of claim 1 where the description of how to manage playback of digital content is used by a digital media player to control playback of digital media content, whether directly or indirectly or by way of a plug-in to a digital media player, with the goal of avoiding unintended silence—“dead air”—and/or of producing a seamless playback experience for the end user.

20. Method of claim 1, wherein (i) the digital media content is digital music content or digital video and audio content, or (ii) the digital media player is a smart phone or a tablet computer, or (iii) the descriptive metadata includes the point of audio end, as distinct to the end of the file, in that it specifies that part of a digital media file after which there is little or no effective audio content in that file, or (iv) the descriptive metadata includes the beginning of audio elements in an audio file, or the descriptive metadata includes one or more of, or all of: General definition; Instructions for caching; Fallback playlist; Streaming playlist, and Links for requesting more playlist items.

21-24. (canceled)

25. Method of claim 1, wherein the descriptive metadata includes information which is interpretable to define one or more of, or all of: Which track(s) to play; At which point to commence the playback of each track; At which point to end playback of each track; How to play each track, in terms of which audio and/or video processing to apply such as the initial volume to use for playback, how to apply normalisation of tracks or any other playback criteria; How to transition from and to each track, such as how to cross-fade between tracks and which interstitials (if any) to utilise to smooth that transition; Which track to play after a given track, given as a simple track identifier or as a set of selection criteria which the client application may use to choose from a selection of possible “next tracks”; How to handle the case where the “next track” is unavailable, whether temporarily or permanently, such as providing a pre-cached track to use as an alternative; How to manage the presentation of the track(s) to the end user in the client's user interface, and How to overlay, whether optionally or otherwise, one track onto another, such as defining commentary tracks of audio, video or text for presentation alongside a currently playing track.

26. Method of claim 1, wherein the method further includes the step of: after opening a session/web player/software app on the digital media player, audio is played only in response to a user-instigated play action.

27. Method of analysing digital content, comprising the steps of:
(a) identifying a collection of digital media files;
(b) performing DSP analysis of the collection of digital media files to automatically generate the audio start and end points within the files, and
(c) generating and storing metadata based on the DSP analysis.

28-35. (canceled)

36. A system including a digital media player and a content server, the digital media player connectable to the content server via a content delivery network, the content server operable to provide content delivery to the digital media player in response to calls to the content server from the digital media player, wherein the system is operable to
(a) identify a description which defines how to manage the playback of one or more items of digital media content, the description including descriptive metadata, and
(b) utilise the description within the digital media player to control automatically the playback of digital media content.

37-38. (canceled)

39. A system including a digital media player, an identification server and a content server, the digital media player, the identification server and the content server connectable to each other via a content delivery network, the content server operable to provide content delivery to the digital media player in response to calls to the content server from the digital media player, wherein
(a) the identification server is operable to identify a description which defines how to manage the playback of one or more items of digital media content, the description including descriptive metadata,
(b) the identification server is operable to transmit the description to the digital media player, and
(c) the digital media player is operable to utilise the description to control automatically the playback of digital media content.

40-43. (canceled)

44. Computer program product operable to perform a method of managing playback of one or more items of digital media content, for example to ensure naturalistic transitioning between items of digital media content, the computer program product operable to perform the steps of:
(a) identifying a description which defines how to manage the playback of one or more items of digital media content, the description including descriptive metadata, and
(b) utilising the description within a digital media player to control automatically the playback of digital media content.

45. (canceled)
